(19) United States
(12) Patent Application Publication
(10) Pub. No.: US 2024/0257590 A1
(43) Pub. Date: Aug. 1, 2024

(54) VEHICULAR ELECTRONIC KEY SYSTEM AND VEHICULAR AUTHENTICATION DEVICE

(71) Applicant: DENSO CORPORATION, Kariya-city (JP)

(72) Inventors: Kenichiro SANJI, Kariya-city (JP); Yohei NAKAKURA, Kariya-city (JP); Takashi SAIKI, Kariya-city (JP); Yasuhiro TANAKA, Kariya-city (JP)

(21) Appl. No.: 18/631,272

(22) Filed: Apr. 10, 2024

Related U.S. Application Data
(63) Continuation of application No. PCT/JP22/37752, filed on Oct. 10, 2022.

(30) Foreign Application Priority Data
Oct. 13, 2021 (JP) 2021-168159

(51) Int. Cl. G07C 9/00; G06F 21/31

(52) U.S. Cl. CPC G07C 9/00309; G06F 21/31; G07C 2209/63

(57) ABSTRACT

A smart key and a mobile terminal store therein key information to be used for authentication with a vehicle to function as a key (key device) of a vehicle. Each of the smart key and the mobile terminal performs communication for authentication with an in-vehicle system or the like by BLE communication. For power saving, the smart key basically operates in a sleep mode in which the BLE communication is not possible. On receiving a wake signal periodically transmitted from the vehicle, the smart key transitions to a state where the BLE communication is possible. When sensing the presence of the mobile terminal within a predetermined distance from the vehicle, the in-vehicle system stops the periodic transmission of the wake signal.

### CROSS REFERENCE TO RELATED APPLICATION

The present application is a continuation application of International Patent Application No. PCT/JP2022/037752 filed on Oct. 10, 2022, which designated the U.S. and claims the benefit of priority from Japanese Patent Application No. 2021-168159 filed on Oct. 13, 2021. The entire disclosures of all of the above applications are incorporated herein by reference.

### TECHNICAL FIELD

The present disclosure relates to a vehicular electronic key system and to a vehicular authentication device.

### BACKGROUND

Conventionally, a wireless key device has been used for operating a vehicle.

### SUMMARY

According to an aspect of the present disclosure, an in-vehicle-system is configured to perform predetermined vehicle control by performing short-range communication.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an overview of a vehicular electronic key system;

FIG. 2 is a block diagram illustrating a configuration of a BLE communication device;

FIG. 3 is a diagram illustrating an example of position at which BLE communication devices and LF transmission devices are to be mounted;

FIG. 4 is a block diagram illustrating a configuration of a smart key;

FIG. 5 is a block diagram illustrating a configuration of a mobile terminal;

FIG. 6 is a functional block diagram illustrating a smart ECU;

FIG. 7 is a diagram illustrating an example of a device registration screen;

FIG. 8 is a flow chart for locking/unlocking area determination processing;

FIG. 9 is a flow chart for a vehicle inside/outside determination processing;

FIG. 10 is a diagram for illustrating a sniffing method;

FIG. 11 is a diagram illustrating an example of control of transmission of a wake signal;

FIG. 12 is a flow chart for a connection-related processing;

FIG. 13 is a flow chart for illustrating an operation of a smart ECU during standby;

FIG. 14 is a flow chart for a temporary response processing;

FIG. 15 is a flow chart corresponding to processing of automatically unregistering a key device according to the number of days elapsed from a date of final use of the smart key;

FIG. 16 is a flow chart for a strength adjustment processing;

FIG. 17 is a diagram for illustrating a modification of a method of estimating a position of the key device;

FIG. 18 is a flow chart illustrating an example of processing when periodic transmission of the wake signal is stopped on the basis of approach of the mobile terminal;

FIG. 19 is a diagram illustrating an example of a configuration in which the LF transmission devices are dispersedly disposed to correspond to individual doors;

FIG. 20 is a diagram for illustrating a calculation principle of a transmission-reception phase difference according to an active two-way method;

FIG. 21 is a diagram for illustrating a calculation principle of a transmission-reception phase difference according to a passive two-way method;

FIG. 22 is a diagram for illustrating a calculation principle of a transmission-reception phase difference according to a one-way method;

FIG. 23 is a diagram illustrating a modification of a mounting pattern of the BLE communication devices or the like; and

FIG. 24 is a diagram illustrating an example of a system configuration that estimates a position of a key device by using UWB communication devices.

### DETAILED DESCRIPTION

Hereinafter, examples of the present disclosure will be described.

According to an example of the present disclosure, a mobile terminal such as a smartphone is used as a key device. An in-vehicle system mounted in a vehicle performs position estimation and authentication processing of a mobile terminal by wireless communication with the mobile terminal based on the Bluetooth (registered trademark) to perform locking/unlocking of a vehicle or the like. Note that the key device mentioned herein refers to a device that functions as a key of a vehicle, which is a device for proving the legitimacy of a person attempting to use the vehicle.

According to an example of the present disclosure, a configuration is employed that performs authentication processing not only with a mobile terminal, but also with a vehicular mobile device by wireless communication. The vehicular mobile device mentioned herein refers to a dedicated device having a function of a vehicle key, which is referred to a key fob, a smart key, a key card, or the like. The vehicular mobile device also corresponds to the key device. In this configuration, communication with the vehicular mobile device is performed using an LF (Low Frequency) band.

Various configurations for accurately estimating positions of mobile terminals are conceivable. For example, a configuration is employable in which communication devices are placed at a plurality of locations in a vehicle, and a position of the vehicle with respect to a mobile terminal is detected on the basis of a status of communication with the mobile terminal in each of the communication devices such as, e.g., a reception strength or a signal flight time.

Even when a mobile terminal can be used as a key device, sales/distribution of a vehicular mobile device need not necessarily be discontinued. It is predicted that a vehicular mobile device will be sold/distributed as a vehicle accessary as proof of ownership or a tangible master key in the future. In addition, it is assumed that some of users may dare to continue to use a vehicular mobile device, not a mobile terminal, as a vehicle key depending on their preferences. In other words, as an in-vehicle device, a configuration capable of communicating with both of a vehicular mobile device and a mobile terminal is in demand.

According to an example of the present disclosure, an in-vehicle device performs authentication with each of the in-vehicle mobile device and the mobile terminal by communication. Consequently, if a user approaches the vehicle while carrying both the mobile terminal and the vehicular mobile device, not only the mobile terminal, but also the vehicular mobile device performs wireless communication with the in-vehicle device, which may result in unnecessary power consumption.

Herein, details of the descriptions in Patent Literature 1: JP2015-214316A, Patent Literature 2: JP2020-182149A, Patent Literature 3: JP2020-26996A, Patent Literature 4: JP2020-26998A, Patent Literature 5: JP2019-158765A, Patent Literature 6: JP2019-73960A, Patent Literature 7: JP2018-141771A, such as, e.g., an algorithm related to determination of the positions of the mobile terminals and device/system configurations can be incorporated herein by reference as explanation of technical elements in this description.

Disclosed herein, in a vehicular electronic key system, an in-vehicle-system is configured to perform predetermined vehicle control by performing short-range communication, which is wireless communication in compliance with a predetermined communication standard using a radio wave in a first frequency band, with a key device, which is a device to be used as a key of a vehicle. The in-vehicle system includes:
a key information storage unit configured to store information on the key device;
a plurality of first communication units that are communication modules configured to perform the short-range communication;
at least one second communication unit that is a communication module configured to
   transmit a predetermined wake signal, which is a wireless signal in a second frequency band different from the first frequency band, and
   temporarily transition a vehicular mobile device, which is a dedicated device to operate the vehicle, to a state where the short-range communication is possible;
a communication control unit configured to control an operation of each of the first communication units and the second communication unit;
a position estimation unit configured to determine a position of the key device with respect to the vehicle, based on statuses of signal reception from the key device by the plurality of first communication units; and
an authentication processing unit configured to authenticate a user based on data received from the key device by the first communication units.

The key information storage unit is configured to register, as the key device, each of the vehicular mobile device and a mobile terminal, which is a versatile information processing device capable of performing the short-range communication. The communication control unit is configured to change, when the mobile terminal is registered as the key device, the operation of the second communication unit, according to the position of the mobile terminal determined by the position estimation unit.

In the system in which each of the mobile terminal and the vehicular mobile device can be used as the key of the vehicle, when the mobile terminal is close to the vehicle, the in-vehicle system can authenticate the user by communication with the mobile terminal. Accordingly, when the mobile terminal is close to the vehicle, the in-vehicle system need not perform the short-range communication with the vehicular mobile device.

The vehicular electronic key system in the present disclosure has been conceived by focusing attention on the points described above, and the vehicular mobile device in the present disclosure first temporarily transitions to the state where the short-range communication can be performed on the basis of reception of the wake signal. In other words, when not receiving the wake signal, the vehicular mobile device may maintain a state where the short-range communication is not performed. Accordingly, it is possible to reduce power consumption in the vehicular mobile device. In addition, the communication control unit changes, according to the position of the mobile terminal, the operation of the second communication unit, i.e., a mode of control of the transmission of the wake signal. For example, when the mobile terminal is close to the vehicle, the communication control unit is allowed to perform control such as stopping of the transmission of the wake signal. When the in-vehicle system does not transmit the wake signal, the vehicular mobile device maintains the state where the short-range communication is not performed on the basis of the wake signal, and consequently it is possible to further reduce the power consumption in the vehicular mobile device. In addition, the in-vehicle system can accordingly reduce the power consumption by an amount corresponding to no transmission of the wake signal.

In the present disclosure, a vehicular authentication device is configured to authenticate a user by performing short-range communication, which is wireless communication in compliance with a predetermined communication standard using a radio wave in a predetermined first frequency band, with a key device, which is a device to be used as a key of a vehicle. The vehicular authentication device comprises:
a key information storage unit configured to store information on the key device;
a first communication control unit configured to control a plurality of first communication units, which are communication modules located at different positions in the vehicle to perform the short-range communication;
a second communication control unit configured to control at least one second communication unit, which is a communication module configured to transmit a predetermined wake signal, which is a wireless signal in a second frequency band different from the first frequency band to temporarily transition a vehicular mobile device, which is a dedicated device to operate the vehicle, to a state where the short-range communication is possible; and
a position estimation unit configured to determine a position of the key device with respect to the vehicle, based on statuses of signal reception from the key device by the plurality of first communication units.

The key information storage unit is configured to register, as the key device, each of the vehicular mobile device and a mobile terminal, which is a versatile information processing device capable of performing the short-range communication. The second communication control unit is configured to change, when the mobile terminal is registered as the key device, an operation of the second communication unit according to the position of the mobile terminal determined by the position estimation unit.

According to the same principle as that of the vehicular electronic key system described above, the vehicular authentication device described above allows a reduction in power consumption in the vehicular mobile device or an in-vehicle system.

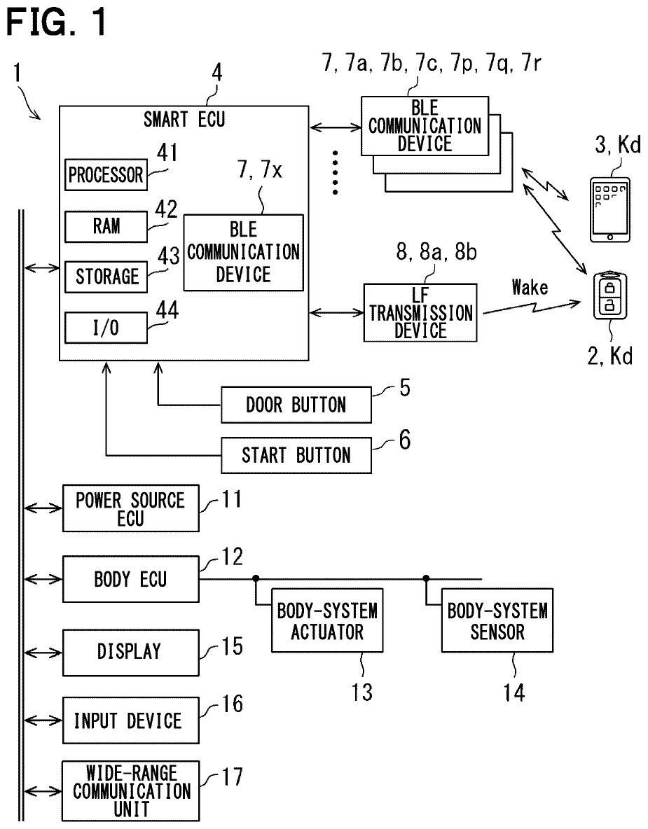

Using the drawings, a description will be given of an example of an embodiment of a vehicular electronic key system according to the present disclosure. FIG. 1 is a diagram illustrating an example of a schematic configuration of the vehicular electronic key system. As illustrating in FIG. 1, the vehicular electronic key system includes an in-vehicle system 1 and a smart key 2. In addition, the vehicular electronic key system includes, as an optional element, one or a plurality of mobile terminals 3. The in-vehicle system 1 is a system mounted in a vehicle Hv. The smart key 2 is a dedicated device as an electronic key of the vehicle Hv. The mobile terminal 3 is a versatile information processing terminal to be carried by a user of the vehicle Hv.

### Introduction

By way of example, the vehicle Hv in the following description is a vehicle owned by an individual person. Accordingly, the user of the vehicle Hv refers to a possessor (owner), his or her family member, or the like. Needless to say, the vehicle Hv may also be a company car owned by a corporate organization or an official car owned by a public institution. When the vehicle Hv is a company car or an official car, a person belonging to an organization managing the vehicle Hv may be the user. Alternatively, the vehicle Hv may be a vehicle provided for a rental service (so-called rental car), or may also be a vehicle provide for a car sharing service (so-called shared car). The vehicle Hv may also be a vehicle provided for a passenger transport service, such as a robot taxi. When the vehicle Hv is a vehicle provided for any of the foregoing services (hereinafter referred to as a service vehicle), a person who has a contract to use such a service and is authorized to temporarily use the vehicle Hv on the basis of a reservation to use the service or the like may be the user.

In the present embodiment, by way of example, the vehicle Hv is assumed to be an engine vehicle. However, the vehicle Hv may also be an electrically powered vehicle such as a plug-in hybrid vehicle or an electric vehicle. It is assumed that the engine vehicle mentioned herein refers to a vehicle including only an engine as a power source, while the hybrid vehicle refers to a vehicle including an engine and a motor each as a power source. The electric vehicle refers to a vehicle including only a motor as a drive source. The present disclosure can be mounted not only in four-wheeled vehicles but also on various vehicles capable of traveling on roads, such as a trailer, a two-wheeled vehicle, a three-wheeled vehicle, and the like. A motorized bicycle can also be included in two-wheeled vehicles. In the present disclosure, it is assumed by way of example that the vehicle Hv is a vehicle in which a driver seat is provided on a right side, but the vehicle Hv may also be a vehicle in which the driver seat is provided on a left side. In the following description, each of forward/rearward, leftward/rightward, and upward/downward directions is defined by using the vehicle Hv as a reference. The forward/rearward direction corresponds to a longitudinal direction of the vehicle Hv. The leftward/rightward direction corresponds to a width direction of the vehicle Hv. The upward/downward direction corresponds to a height direction of the vehicle Hv.

### General Overview

Each of the in-vehicle system 1, the smart key 2, and the mobile terminal 3 is configured to be able to perform communication (hereinafter referred to as short-range communication) based on a predetermined short-range wireless communication standard such that a substantial communicative distance is, e.g., 5 m to 30 m, and at most about 100 m. As the short-range communication standard mentioned herein, e.g., BLE (Bluetooth Low Energy, where Bluetooth is a registered trademark), Wi-Fi (registered trademark), a ZigBee (registered trademark), or the like can be used. As a short-range communication technology, UWB-IR (Ultra Wide Band-Impulse Radio) can also be used. Short-range communication is performed using a high-frequency radio wave. Note that the high-frequency radio wave in the present disclosure refers to a radio wave at 900 MHz or more such as, e.g., 2.4 GHz. The high-frequency radio wave includes not only a radio wave at 1 GHz or more, but also a radio wave in a sub-Giga band including 920 GHz or the like.

By using a case where each of the vehicle system 1, the smart key 2, and the mobile terminal 3 is configured to be able to perform wireless communication in compliance with a BLE standard (hereinafter referred to the BLE communication) as an example, an operation of each of the units will be described. Details of a communication method related to communication connection, encrypted communication, or the like are implemented by a sequence defined by the BLE standard.

Note that the following will describe a case where a BLE communication device 7 mounted in the vehicle Hv behaves as a master in communication with the smart key 2 or the mobile terminal 3. Each of the smart key 2 and the mobile terminal 3 behaves as a slave. The slave in the BLE communication is a device that intermittently transmits an advertise signal, while performing data transmission/reception on the basis of a request from the master. The slave is referred to also as a peripheral. The master is a device that controls a state of communication connection and communication timing with the slave. The master is referred to also as a central. In another mode, each of the smart key 2 and the mobile terminal 3 may also be set to operate as the master in communication with the in-vehicle system 1.

Note that the advertise signal is a signal for notifying another device of its own existence. An advertise signal can be referred to as an advertise frame or an advertise packet. A signal transmitted/received in the BLE, such as the advertise signal, includes source information. The source information is specific identification information allocated to, e.g., the mobile terminal 3 (hereinafter referred to as the device ID). As the device ID, e.g., a device address, a UUID (Universally Unique Identifier), or the like can be used. Note that the device address in the Bluetooth can be represented by 48 bits. Meanwhile, the UUID can be represented by 128 bits. The device address may be a static public address, or may also be a random address. The public address corresponds to a MAC (Media Access Control) address in the Ethernet (registered trademark).

The smart key 2 and the mobile terminal 3 are devices each holding key information for using the vehicle Hv to function as an electronic key of the vehicle Hv by using the key information. The key information mentioned herein is data to be used in authentication processing described later. The key information is data for proving that a person attempting to access the vehicle Hv is the user, i.e., legitimacy of the person attempting to access the vehicle Hv. The key information can be referred to as an authentication key, an encryption key, a key code or the like. The key information can be, e.g., a character string (value) obtained by inputting a password set by the user to a predetermined hash function and encrypting the password. The key information may also be generated on the basis of the device ID. In the present disclosure, each of the smart key 2 and the mobile terminal 3 is referred to also as a key device Kd.

The key information may differ from one key device Kd to another. In the in-vehicle system 1, the key information for each of the key devices Kd is associated with the device ID and saved/registered. The plurality of key devices Kd can be distinguished by key IDs allocated by the vehicle Hv in order of registration, instead of the device IDs. Each of the devices IDs is represented by a length of, e.g., about 48 bits/128 bits, while each of the key IDs may be represented by several bytes such as, e.g., 1 byte. The key information may be represented by a bit string having a length of 1 byte or more. As the key information is longer, a security property is favorably stronger. The key information may be represented by, e.g., 16 bytes, 27 bytes, or the like. A configuration using the key information of 27 bytes or less allows the entire key information to be transmitted in one packet in BLE encrypted communication.

The in-vehicle system 1 performs automatic authentication processing by wireless communication with the various key devices Kd. Then, on the condition that the authentication is successful, it implements a passive entry/passive start system that performs vehicle control according to a position of the user with respect to the vehicle Hv. The vehicle control mentioned herein is locking/unlocking of a door, turning ON/OFF of a power source, engine starting, or the like.

For example, when having successfully recognized that the key device Kd is present within a locking/unlocking area Lx set in advance with respect to the vehicle Hv, the in-vehicle system 1 performs control such as locking or unlocking of a door on the basis of a user operation performed on a door button 5 described later. Meanwhile, when having successfully recognized that the key device Kd is present in the vehicle interior by wireless communication with the key device Kd, the in-vehicle system 1 performs control of starting the engine on the basis of a user operation performed on a start button 6 described later.

The locking/unlocking area Lx is an area outside the vehicle interior where the in-vehicle system 1 is to perform predetermined vehicle control such as locking or unlocking of the door on the basis of the presence of the key device Kd in the area. The locking/unlocking area Lx can be referred to also as an outdoor operation area or a passive entry area. For example, the vicinity of a door for the driver seat, the vicinity or a door for a front passenger seat, and the vicinity of a trunk door are set in the locking/unlocking area Lx. The vicinity of the door refers to a range within a predetermined operation distance from an outer door handle. The outer door handle refers to a holding member provided in an outer surface of the door to allow the door to be opened/closed. The operation distance defining a size of the locking/unlocking area Lx is, e.g., 1.5 m. Needless to say, the operation distance may be 1 m, or may also be 0.7 m. The operation distance is set smaller than 2 m from a security viewpoint.

Authentication of the key device Kd by the in-vehicle system 1 may be performed by, e.g., a challenge-response method. The authentication processing involves processing of comparing a response code generated by the key device Kd on the basis of the key information to a verification code held or dynamically generated by the vehicle Hv, and can therefore be referred to also as comparison processing. Details of the authentication processing will separately be described later. Successful authentication of the key device Kd corresponds to determination of a person attempting to access the vehicle Hb to be an authorized user.

### <Configuration of In-Vehicle System 1>

A description will be given herein of a configuration and an operation of the in-vehicle system. As illustrated in FIG. 1, the in-vehicle system 1 includes a smart ECU 4, the door button 5, the start button 6, the BLE communication device 7, and an LF transmission device 8. The in-vehicle system 1 includes a power source ECU 11, a body ECU 12, a body-system actuator 13, body-system sensors 14, a display 15, an input device 16 and a wide-range communication unit 17. In the member name, ECU is an abbreviation of Electronic Control Unit, and means the electronic control unit. LF is an abbreviation of Low Frequency.

The smart ECU 4 is connected to each of the plurality of door buttons 5, the start button 6, the plurality of BLE communication devices 7, and the LF communication device 8 via a dedicated signal line. The smart ECU 4 is also connected to each of the power source ECU 11, the body ECU 12, the display 15, the input device 16, and the like via an in-vehicle network Nw to be communicative with each other. The in-vehicle network Nw is a communication network built in the vehicle Hv. As a standard for the in-vehicle network Nw, various standards such as Controller Area Network (hereinafter referred to as the CAN: registered trademark) and the Ethernet can be used. Note that a part of the body ECU 12 or the like may also be connected to the smart ECU 4 via a dedicated line without interposition of the in-vehicle network Nw. A configuration of connection between devices can be changed as appropriate.

The smart ECU 4 estimates the position of the key device Kd through cooperation with the BLE communication devices and the like. In addition, the smart ECU 4 implements vehicle control according to a result of the estimation of the position of the key device Kd through cooperation with another ECU. The smart ECU 4 is implemented using a computer. In other words, the smart ECU 4 includes a processor 41, a RAM 42, a storage 43, an I/O 44, a bus line connecting these configurations, and the like. The smart ECU 4 in the present embodiment is embedded in one of the BLE communication devices 7. The smart ECU 4 corresponds to a vehicular authentication device.

The processor 41 is hardware (i.e., an arithmetic core) for arithmetic processing connected to the RAM (Random Access Memory) 42. The processor 41 is a CPU (Central Processing Unit), for example. The processor 41 performs various processing for implementing respective functions of individual functional units described later by accessing the RAM 42. The RAM 42 is a volatile storage medium. The storage 43 has a configuration including a nonvolatile storage medium such as a flash memory. In the storage 43, various programs to be executed by the processor 41 are stored. The execution of a program by the processor 41 is equivalent to implementation of a method corresponding to the program, e.g., a position estimation method. The I/O 44 is a circuit module for communicating with another device. The I/O 44 is implemented using analog circuit elements and an IC or the like.

In the storage 43, the device IDs corresponding to the individual key devices Kd are registered. Additionally, in the storage 43, communication device setting data indicating respective positions at which the individual BLE communication devices 7 are mounted in the vehicle Hv is stored. Each of the positions at which the individual BLE communication devices 7 are mounted may be represented as, e.g., a point in a vehicle coordinate system which is a two-dimensional coordinate system centered at any position in the vehicle Hv and parallel to both of a width direction and a front-rear direction of the vehicle Hv. An X-axis forming the vehicle coordinate system can be set parallel to the vehicle width direction, while a Y-axis forming the vehicle coordinate system can be set parallel to the front-rear direction of the vehicle. As a center of the vehicle coordinate system, e.g., a center of a vehicle body, a center of a rear axle, or the like can be used.

To the individual BLE communication devices 7 included in the in-vehicle system 1, respective specific communication device numbers are set. The communication device numbers function as information for identifying the plurality of BLE communication devices 7. In the storage 43, as communication device setting data, the positions at which the individual BLE communication devices 7 are provided are stored in association with the communication device numbers. Details of functions of the smart ECU 4 will separately be described later.

The door button 5 is a button for the user to unlock and lock a door of the vehicle Hv. The door button 5 is provided in the outer door handle provided in each of the doors or in the vicinity thereof. When pressed by the user, the door button 5 outputs an electric signal indicative thereof to the smart ECU 4. Note that, as a configuration for receiving at least one of an unlocking instruction and a locking instruction from the user, a touch sensor can also be used. The touch sensor is a device that detects a touch on the door handle by the user. The touch sensor may be provided instead of the door button 5 or together with the door button 5 in the outer door handle.

The start button 6 is a push switch for the user to switch a driving power source between ON/OFF states. The driving power source is a power source for the vehicle Hv to drive, and refers to an ignition power source when the vehicle is an engine car. When the vehicle Hv is an electric car or a hybrid car, the driving power source refers to a system main relay. The start button 6 can also be considered to be a switch for starting a drive source (e.g., engine). When a push operation is performed by the user on the start button 6, the start button 6 outputs an electric signal indicative thereof to the smart ECU 4.

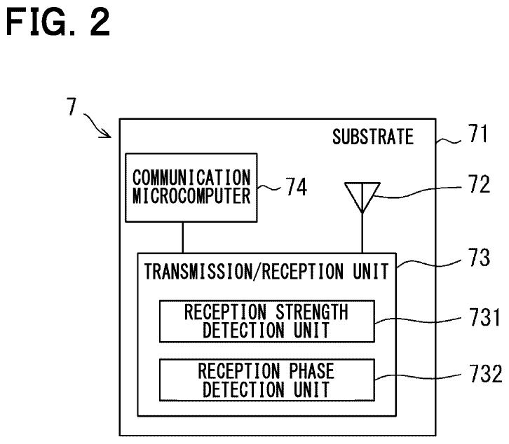

The BLE communication devices 7 are communication modules for performing wireless communication with the key devices Kd such as the smart key 2 and the key device Kd according to the BLE standard. As illustrated in FIG. 2, the individual BLE communication devices 7 include a substrate 71, an antenna 72, a transmission/reception unit 73, and a communication microcomputer 74. The substrate 71 is a print board. On the substrate 71, electronic components included in the BLE communication devices 7 such as, e.g., the antenna 72 are provided. The antenna 72 is an antenna for transmitting/receiving a radio wave in a frequency band to be used for the BLE communication, i.e., a 2.4 GHz band. The antenna 72 is electrically connected to the transmission/reception unit 73. The frequency band to be used for the BLE communication corresponds to a first frequency band. The antenna 72 may also be configured as an array antenna including a plurality of antenna elements arranged therein.

The transmission/reception unit 73 demodulates a signal received by the antenna 72 and provides the signal to the communication microcomputer 74. The transmission/reception unit 73 also modulates a signal input thereto from the smart ECU 4 via the communication microcomputer 74 and outputs the signal to the antenna 72 to cause the signal to be radiated as a radio wave. The transmission/reception unit 73 is mutually communicatively connected to the communication microcomputer 74. The transmission/reception unit 73 includes a reception strength detection unit 731 and a reception phase detection unit 732. The reception strength detection unit 731 is configured to sequentially detect a strength of the signal received by the antenna 72. A signal indicating a reception strength detected by the reception strength detection unit 731 or a measurement value thereof may be referred to also as a RSSI (Received Signal Strength Indicator/Indication). The reception strength detected by the reception strength detection unit 731 is associated with the device ID indicating a source of the received signal to be sequentially provided to the communication microcomputer 74.

Meanwhile, when receiving a continuous wave (CW: Continuous Wave) for ranging, the reception phase detection unit 732 detects a reception phase which is a phase angle of the received signal with respect to an output signal from a local oscillator. The reception phase corresponds to an output value from an arc tangent receiving, e.g., a ratio of a Q (Quadrature-Phase) component of the received signal to an I (In-Phase) component thereof as an input value. A magnitude of the I component corresponds to a strength of an in-phase component of the received signal. A magnitude of the Q component corresponds to a strength of an orthogonal component of the received signal. The I component can be obtained by multiplying the received signal by a carrier wave output from the local oscillator. Meanwhile, the Q component can be obtained by multiplying the received signal by a phase shift signal obtained by shifting a phase of the output signal from the local oscillator by 90°. The phase sift signal can be obtained by causing the output signal from the local oscillator to pass through a phase shift circuit, which is a circuit that shifts a phase by 90°. The local oscillator is a circuit that generates a sine wave or a cosine wave of a carrier frequency, and is implemented using, e.g., a voltage-controlled oscillator (VCO: Voltage-Controlled Oscillator) or the like. A phase detected by the reception phase detection unit 732 is associated with a frequency of the received signal and output to the communication microcomputer 74. The reception phase may also be specified on the basis of an IQ signal at a frequency reduced to a baseband.

The communication microcomputer 74 is a microcomputer that controls data exchange with the smart ECU 4. The communication microcomputer 74 is implemented using CPU, RAM, ROM (Read Only Memory) or the like. The communication microcomputer 74 provides received data input thereto from the transmission/reception unit 73 to the smart ECU 4 in sequential order or on the basis of a request from the smart ECU 4. The communication microcomputer 74 also has a function of authenticating the key device Kd and performing encrypted communication with the key device Kd on the basis of a request from the smart ECU 4. As a method for encryption, various methods can be incorporated.

The communication microcomputer 74 outputs, to the smart ECU 4, data indicating the reception strength detected by the reception strength detection unit 731 on the basis of the request from the smart ECU 4. Note that the communication microcomputer may also be configured to sequentially output the reception strength data to the smart ECU 4 irrespective of the presence or absence of a request from the smart ECU 4. The communication microcomputer 74 outputs, to the smart ECU 4, reception phase information at each frequency on the basis of a request from the smart ECU 4 or spontaneously.

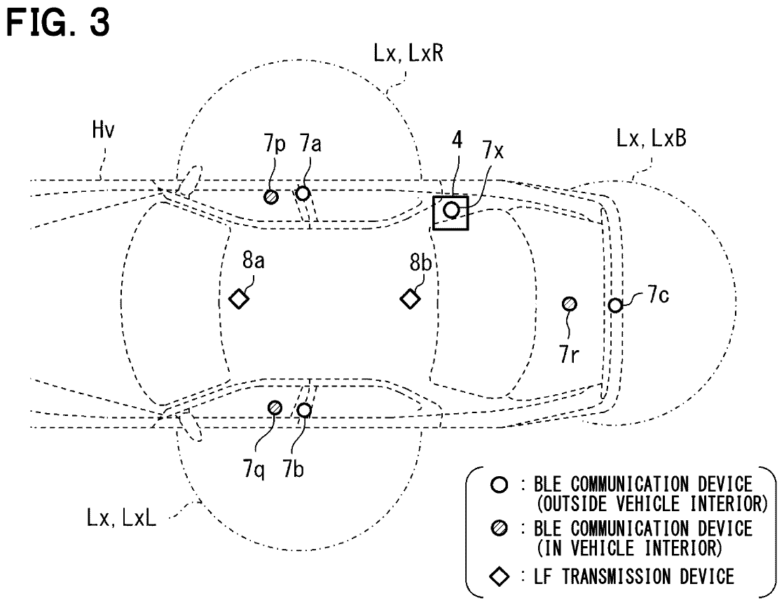

The number of the BLE communication devices 7 provided in the vehicle Hv is at least 1. In the present embodiment, by way of example, the one BLE communication device 7 is embedded in the smart ECU 4. Outside the smart ECU 4 also, the plurality of BLE communication devices 7 are dispersedly located at a plurality of locations in the vehicle. In the present embodiment, by way of example, as illustrated in FIG. 3, it includes the BLE communication devices 7a to 7c, 7p to 7r and 7x.

The BLE communication device 7a is provided on an outer surface of a B-pillar at a right door. The BLE communication device 7b is provided on an outer surface of the B-pillar at a left door. For example, the BLE communication devices 7a and 7b are located at areas of the B-pillars included in left and right doors which are within 30 cm above a belt line. The belt line is a line along lower end portions of side windows, and may be referred to also as a waist line. The BLE communication device 7c is located at a middle portion of a rear bumper in a leftward/rightward direction.

The BLE communication devices 7a to 7c correspond to outdoor devices corresponding to the BLE communication devices 7 provided on an outer surface of the vehicle. Each of the BLE communication devices 7a to 7c serving as the outdoor devices corresponds to a configuration mainly for receiving a signal from the key device Kd present outside the vehicle. Each of the outdoor devices is preferably disposed in the vicinity of the B-pillar or an outer door handle so as to be able to excellently receive the signal from the key device Kd carried by the user attempting to get in the vehicle Hv. In the present embodiment, by way of example, the individual outdoor devices form the individual locking/unlocking areas Lx. For example, the BLE communication device 7a forms a right area LxR, which is the locking/unlocking area Lx on a right side of the vehicle. Meanwhile, the BLE communication device 7b forms a left area LxL, which is the locking/unlocking area Lx on a left side of the vehicle. The BLE communication device 7c forms a back area LxB, which is the locking/unlocking area Lx on a back side the vehicle.

Note that, as the B-pillars, there are a door-side B-pillar included in a door module and a vehicle-body-side B-pillar serving as a support pillar/frame including a roof portion of the vehicle body. The door-side B-pillar corresponds to a portion of a front seat door or a back seat door which comes into contact with the vehicle-body-side pillar. The B-pillar in the following mainly refers to the door-side B-pillar. In addition, unless otherwise specified, it is assumed that the door-side B-pillar corresponding to a position at which the outdoor device is to be mounted refers to a portion adjacent to the side window, i.e., a portion above a lower end portion of the side window. In another mode, the outdoor device may also be disposed in a portion below a window frame of the door-side B-pillar or in the vehicle-body-side B-pillar. The B-pillar refers to a second pillar from the front among pillars included in the vehicle Hv. The B-pillar may be referred to also as a center pillar. A third pillar from the front or a pillar located behind a back seat is referred to as a C-pillar. An A-pillar corresponds to a frontmost pillar, which is the pillar located in front of the front seat.

The BLE communication device 7p is located at a position on an in-vehicle-side planar portion of a metal panel forming a right front door which is 0.1 m or more below a window portion. For example, the BLE communication device 7p is disposed in an area of an in-vehicle-side surface of the right front door which is within 20 cm from a floor. The right front door refers to a door for a front seat on the right side. The BLE communication device 7q is located at a position corresponding to the BLE communication device 7p on the left side of the vehicle. In other words, the BLE communication device 7q is located at a position on an in-vehicle-side planar portion of a metal panel forming a left front door which is 0.1 m or more below a window portion. A left front door refers to a door for a front seat provided on the left side of the vehicle. The BLE communication device 7r is provided in a trunk room or in a rear surface portion of a seat back portion of the back seat.

The BLE communication devices 7p to 7r correspond to indoor devices, which are the BLE communication devices 7 provided in the vehicle interior. Each of the BLE communication devices 7p to 7r serving as the indoor devices corresponds to a configuration mainly for receiving a signal from the key device Kd present inside the vehicle.

The indoor devices are preferably provided at positions at which the outside of the vehicle is out of sight. An “out-of-sight” area for a given one of the BLE communication devices 7 is an area not directly reached by a signal transmitted from the BLE communication device 7. Note that the signal transmitted from the BLE communication device 7 is reflected by various structures to possibly reach the out-of-sight area. In other words, even when the key device Kd is present in the out-of-view area of the BLE communication device 7, the two devices may perform wireless communication therebetween by reflection, diffraction, or the like, by the structures.

The indoor devices are located at positions away from positions paired with the outdoor devices with metal plates such as doors being interposed therebetween. The paired positions refer to positions having a back-front relationship therebetween with a metal body being interposed therebetween. More specifically, a range at a distance from the outdoor device which is less than 20% of a target wavelength may correspond to a position paired with the outdoor device. The position away from the paired position is a position not satisfying the condition described above. For example, the indoor device is located at a position away from the outdoor device by 20% or more, or more preferably 40% or more of the target wavelength. Th target wavelength mentioned herein is a wavelength of a signal to be subjected to the BLE communication, which is about 122 mm. 20% of the target wavelength is about 2.5 cm, while 40% thereof is about 5 cm. The arrangement mode described above corresponds to a configuration in which the indoor device is located at a position away from the outdoor device by at least 10 cm or more in an up-down or front-rear direction.

The BLE communication device 7x is embedded in the smart ECU 4. By way of example, FIG. 3 illustrates a mode in which the smart ECU 4 is attached to a right C-pillar. The smart ECU 4 may also be contained in an instrument panel. As a portion in which the smart ECU 4 is to be contained, the inside of an upper surface portion of the instrument panel, the inside of a center garnish, or the like can be used. The BLE communication device 7x is preferably located at a position where the BLE communication device 7x can also communicate with the key device Kd present not only in the vehicle interior, but also outside the vehicle. The smart ECU 4 including the BLE communication device 7x may also be located at a position where the smart ECU 4 can view outside the vehicle via the window portion, such as the roof portion of the vehicle interior. Alternatively, the BLE communication device 7x may also be disposed outside the smart ECU 4.

Note that the positions at which the BLE communication devices 7 are to be mounted described above are an example, and can be changed as appropriate. For example, the BLE communication devices 7a and 7b serving as the outdoor devices may be embedded in outer door handles for the front seats, or may also be disposed in locker portions below doors or the like. The locker portions also include inner portions of side sill covers. A position at which the BLE communication device 7c is to be mounted may also be in the vicinity of a rear number plate, the vicinity of a rear window, the vicinity of a door handle for the trunk, or the like. In the description of the positions at which the BLE communication devices 7 are to be mounted, the “vicinity” of a given member refers to a range within, e.g., 30 cm from the member. For example, the vicinity of the number plate refers to a range within 30 cm from the number plate. The vicinity of the door handle also includes the inner portions of the door handle.

The BLE communication devices 7p and 7q serving as the indoor devices may also be located at the base of the vehicle-body-side B-pillar or in the vicinity of feet of a driver and a front seat passenger. The base of the vehicle-body-side B-pillar refers to a portion within 20 cm from a floor surface. Each of the BLE communication devices 7p and 7q may also be disposed in the vicinity of an inner door handle or in a door switch panel, a door pocket, an arm rest, or the like. The BLE communication device 7r may also be buried in a center of the back seat or the like.

The number of the BLE communication devices 7 included in the in-vehicle system 1 may be 6 or less, or may also be 8 or more. The in-vehicle system 1 may 1 may also include the BLE communication device 7 disposed in the vicinity of a front bumper/emblem.

Among the BLE communication devices 7 included in the in-vehicle system 1, the BLE communication device 7 to be used for data communication with the key device Kd is referred to as a representative device or a gateway communication device in the present disclosure. In the present disclosure, the BLE communication device 7x basically operates as the representative device. Setting of the representative device may dynamically be changed by the processor 41.

The smart ECU 4 uses any of the plurality of BLE communication devices 7 to execute a key exchange protocol with the key device Kd (so-called pairing). Device information, which is information about the key device Kd acquired by the pairing, is stored in the storage 43, and is also stored in a nonvolatile memory included in the communication microcomputer 74 of each of the BLE communication devices 7. Examples of the device information include the key exchanged by the pairing, the device ID, and the like. Note that, when the vehicle Hv is to be shared among a plurality of the users, the device information is stored for each of the key devices Kd possessed by the individual users. When the vehicle Hv is a service car, the smart ECU 4 may 4 may also acquire, from a management server that issues the key information, the device information corresponding to the user who made a reservation to use the vehicle Hv in advance and temporarily store the device information on a predetermined storage medium.

The BLE communication device 7x and accordingly the in-vehicle system 1 receive signals transmitted from the mobile terminal 3 and the smart key 2, e.g., the advertise signal and a scan response signal to detect that the mobile terminal 3 is present within a range where the mobile terminal 3 can perform short-range communication with the in-vehicle system 1. The scan response signal corresponds to a response signal generated from the slave to a scan request signal issued from the master. By way of example, the in-vehicle system 1 detects herein the key device Kd present around the vehicle by using a passive scan method. The in-vehicle system 1 may also retrieve the key device Kd by an active scan method involving transmission of a scan request. The two types of scan methods may also be used selectively according to a scene.

When receiving the advertise signal or the scan response signal from the key device Kd, the BLE communication device 7x uses the stored device information to automatically establish communication connection to the key device Kd. Then, the smart ECU 4 performs encrypted data communication with the key device Kd. Note that, when having established the communication connection to the key device Kd, the BLE communication device 7x provides the device ID of the key device Kd to which the BLE communication device 7x is connected for communication as connected device information to the smart ECU 4.

Note that, in the BLE communication, in a state where the communication connection is established between the devices, data transmission/reception is performed, while 37 channels are sequentially changed. The BLE communication device 7x serving as the representative device sequentially provides, to a communication control unit F2, information indicating the channel (hereinafter referred to as channel information) to be used for communication with the key device Kd. The channel information may be a specific channel number, or may also be a parameter (so-called hopIncrement) indicating a transition rule for the channel in use. The HopIncrement is a number from 5 to 16 randomly determined at the time of communication connection. The channel information preferably includes a current channel number and the HopIncrement.

Each of the BLE communication devices 7 provided outside the smart ECU 4 is mutually communicatively connected to the smart ECU 4 via a dedicated communication line or the in-vehicle network Nw. Each of the BLE communication devices 7 operates on the basis of a control signal from the communication control unit F2 included in the smart ECU 4. In addition, each of the BLE communication devices 7 provides the received data or information related to a status of signal reception from the key device Kd to the smart ECU 4. The information related to the status of signal reception from the key device Kd will be separately described later.

The LF transmission device 8 is a device that transmits a signal at a predetermined frequency belonging to an LF band on the basis of an instruction from the smart ECU 4. A LF band corresponds to a second frequency band. The LF band mentioned herein indicates 30 kHz to 300 kHz. The frequency in the LF band to be used for signal transmission from the in-vehicle system 1 to the smart key 2 is, e.g., 125 kHz or 134 kHz. A wireless signal in the LF band is hereinafter referred to also as the LF signal. The LF transmission device 8 transmits the wake signal on the basis of an input signal from the smart ECU 4, for example. The wake signal is the LF signal for causing the smart key 2 to shift to an active mode. The LF transmission device 8 includes a LF transmission circuit and a LF transmission antenna. The LF transmission circuit is a circuit that performs predetermined signal processing such as digital-analog conversion, frequency conversion, or modulation. The LF transmission circuit may also be included in the smart ECU 4.

As illustrated in FIG. 3, the in-vehicle system 1 includes LF transmission devices 8a and 8b as the LF transmission device 8. The LF transmission device 8a is provided in, e.g., a middle portion of the instrument panel in the vehicle width direction or in the vicinity of a center console box. The LF transmission device 8b is buried in a seating surface of the back seat. Note that the LF transmission device 8a may also be provided in the roof portion. The LF transmission device 8b may also be disposed in the trunk. The positions at which the LF transmission devices 8 are to be provided and the number of the LF transmission devices 8 to be provided can also be changed as appropriate. For each of the LF transmission devices 8, transmission power and a portion in which the LF transmission device 8 is to be mounted are set such that an effective communication area is within 5 m from the vehicle, including the vehicle interior. The effective communication area refers to a range in which the wake signal propagates, while retaining a predetermined strength.

The power source ECU 11 is an ECU that controls an ON/OFF state of the driving power source mounted in the vehicle Hv. For example, the power source ECU 11 sets the driving power source in the ON state on the basis of an instruction signal from another ECU such as, e.g., the smart ECU 4. Note that, when the vehicle Hv is the engine car, the power source ECU 11 starts the engine on the basis of the instruction signal mentioned above.

The body ECU 12 is an ECU that controls the body-system actuator 13 on the basis of a request from the smart ECU 4 or the user. The body ECU 12 is communicatively connected to the various body-system actuators 13 and the various body-system sensors 14. Examples of the body-system actuators 13 mentioned herein include a door lock motor included in a lock mechanism of each of the doors. The body-system sensors 14 include a courtesy switch disposed for each of the doors and the like. The courtesy switch is a sensor that detects opening/closing of the door. The body ECU 12 locks and unlocks each of the doors by outputting a predetermined control signal to the door lock motor provided in each of the doors of the vehicle Hv on the basis of, e.g., a request from the smart ECU 4.

The display 15 is a device that displays an image. For example, the display 15 may display, on the basis of an input thereto from the smart ECU 4, a screen for registering the key device Kd, a screen for deleting the registered key device Kd, and the like. As the display 15, e.g., a liquid crystal display, an OLED (Organic Light Emitting Diode) display, or the like can be used. The display 15 is a center display provided in, e.g., the middle region of the instrument panel in the vehicle width direction. The display 15 may also be a meter display disposed in a front region of the driver seat.

The input device 16 is a device for receiving an instruction operation performed by the user on the in-vehicle system 1, more specifically the smart ECU 4. As the input device 16, a steering switch or a touch panel laminated on the display 15 can be used. The display 15 and the input device 16 correspond to an interface for the user to register the mobile terminal 3 as the key device Kd or delete a device registered as the key device Kd. The input device 16 outputs, as an operation signal, an electric signal corresponding to the operation performed by the user on the device to the smart ECU 4. The operation signal output from the input device 16 indicates details of the operation performed by the user.

The wide-range communication unit 17 is a communication module for accessing the Internet by cellular communication or Wi-Fi communication. The cellular communication mentioned herein refers to 4G, 5G, or the like. In the present disclosure, communication that allows an access to the Internet, such as 4G, 5G, or Wi-Fi, is referred to also as wide-range communication. Note that, when the vehicle Hv is a service car, the smart ECU 4 performs data communication with the management server disposed outside the vehicle via the wide-range communication unit 17. The management server may distribute a status of reservation of the vehicle Hv and data related to the user who has reserved the vehicle Hv for use to the smart ECU 4. Distributed data related to a reservation holder may include device information, key information, or the like of the mobile terminal 3 carried by the user. The management server corresponds to an external server.

### <Smart Key 2>

The smart key 2 is a dedicated device as an electronic key for accessing the vehicle Hv. The smart key 2 is a device provided to an owner together with the vehicle Hv at the time of purchase of the vehicle Hv. The smart key 2 is basically carried by the owner. The smart key 2 can be considered to be one of accessories of the vehicle Hv. The smart key 2 can have various shapes such as a flat cuboid shape, a flat ellipsoidal shape (so-called fob type), and a card shape. The smart key 2 may 2 may be referred to also as a vehicular mobile device, a key fob, a smart key, a key card, or the like.

The smart key 2 has, as operation modes, the active mode in which BLE communication is possible and a sleep mode as a mode that limits functions which can be performed therein compared to those in the active mode to reduce power consumption. The sleep mode corresponds to a state where, e.g., a power supply to the BLE communication unit 23 is stopped to stop the operation thereof.

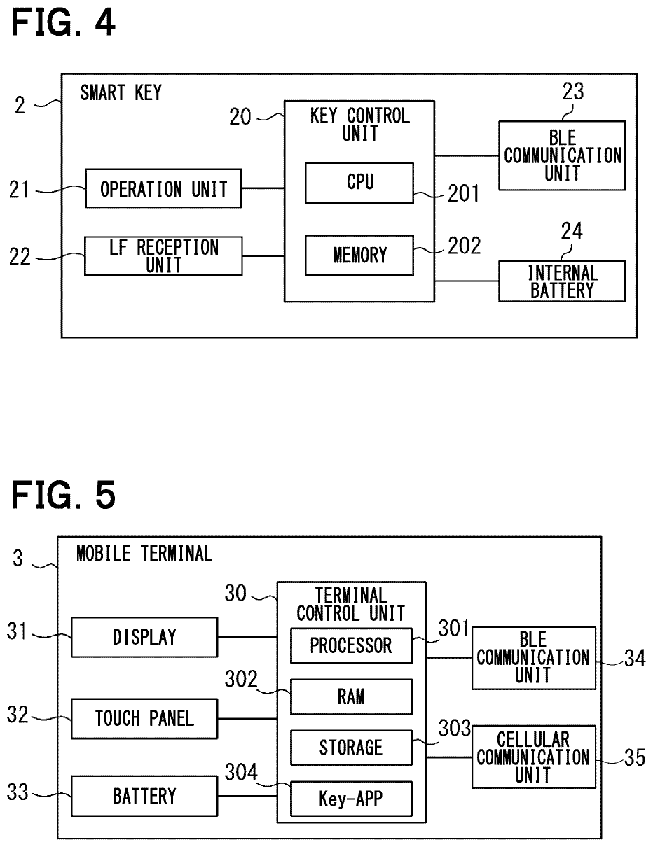

As illustrated in FIG. 4, the smart key 2 includes a key control unit 20, an operation unit 21, an LF reception unit 22, the BLE communication unit 23 and an internal battery 24.

The operation unit 21 is a configuration for receiving a user operation performed on the smart key 2. As the operation unit 21, a push switch or the like can be used. The operation unit 21 may also include a plurality of switches. For example, the operation unit 21 may include a locking switch as a switch for locking the doors of the vehicle Hv and an unlocking switch as a switch for unlocking the doors of the vehicle Hv. Note that the operation unit 21 may also be implemented by a combination of a display and a touch panel. The smart key 2 provides a so-called remote keyless entry system that wirelessly transmits a remote control signal corresponding to the switch operated by the user toward the smart ECU 4 to perform control such as locking/unlocking of the vehicle doors.

The LF reception unit 22 is a configuration for receiving the LF signal which is a wireless signal at a predetermined frequency belonging to the LF band. The LF reception unit 22 is implemented using an antenna for receiving the LF signal and a circuit (so-called demodulation circuit) that demodulates the received signal. The LF reception unit 22 performs predetermined processing, such as analog-digital conversion, demodulation, or decryption on the signal received by the antenna to extract data included in the received signal. Then, the LF reception unit 22 provides the extracted data to the key control unit 20.

The BLE communication unit 23 is a communication module for BLE. A schematic configuration of the BLE communication unit 23 can be the same as that of the BLE communication device 7. The BLE communication unit 23 operates under the control of the key control unit 20. For example, an operating state of the BLE communication unit 23 is switched by the key control unit 20. The BLE communication unit 23 includes an active state where the advertise signal and the like can be transmitted/received and a non-active state where communication is not possible. The non-active state can be, e.g., a non-energized state. The internal battery 24 is a power source that supplies power for the operation of the smart key 2. The internal battery 24 is a primary battery such as, e.g., a lithium battery.

The key control unit 20 is configured as a microcomputer including a CPU 201 and a memory 202. The key control unit 20 can also be implemented using an IC (Integrated Circuit) or a FPGA (Field-Programmable Gate Array). In a memory 202, the key-related information is stored. The key-related information refers to, e.g., the key information, the corresponding vehicle ID, and the like.

The key control unit 20 is activated on the basis of reception of the wake signal having a strength of a predetermined threshold or more by the LF reception unit 22 to cause the entire smart key 2 to shift from the sleep mode to the active mode. The key control unit 20 may be shifted from the sleep mode to the active mode not only when the wake signal is received, but also when the operation unit 21 is operated. In other words, the key control unit 20 is triggered by the reception of the wake signal or a user operation performed on the operation unit 21 to activate the BLE communication unit 23.

During the active mode, the key control unit 20 acquires, from the BLE communication unit 23, information indicating a state of the communication connection to the in-vehicle system 1 and received data from the in-vehicle system 1. When the BLE communication unit 23 receives a challenge code, the key control unit 20 generates a response code using the key information stored in the memory 203 and causes the BLE communication unit 23 to transmit the response code. Even when the operation unit 21 is operated, the key control unit 20 causes the BLE communication unit 23 to transmit a control signal according to details of the operation.

In addition, when a state where no communication connection to the in-vehicle system 1 is detected continues for a given period in the active mode and when a state where the operation unit 21 is not operated continues for a given period, the key control unit 20 shifts the smart key 2 to the sleep mode.

### <Mobile Terminal 3>

The mobile terminal 3 is a portable and versatile information processing device having a BLE communication function. A digital key application 304 which is an application for causing to function as the electronic key of the vehicle Hv is installed. As the mobile terminal 3, e.g., a smartphone, a table terminal, a wearable device, or the like can be used. The wearable device is a device used by being attached to a body of the user, and wearable devices in various shapes such as a wristband type, a wrist watch type, a ring type, an eyeglass type, and an earphone type can be used.

As illustrated in FIG. 5, the mobile terminal 3 includes a terminal control unit 30, a display 31, a touch panel 32, a battery 33, a BLE communication unit 34, and a cellular communication unit 35.

The display 31 is a liquid crystal display, an organic EL display or the like, for example. The display 31 displays an image according to an input signal from the terminal control unit 30. The touch panel 32 is a capacitive touch panel, and is laminated on the display 31. The touch panel 32 and the display 31 correspond to an interface for the user to register the key information in the mobile terminal 3 and pair the mobile terminal 3 with the in-vehicle system 1. The battery 33 is a secondary battery such as, e.g., a lithium ion battery.

The BLE communication unit 34 is a communication module for performing the BLE communication. A schematic configuration of the BLE communication unit 34 can be the same as that of the BLE communication device 7. The BLE communication unit 34 is mutually communicatively connected to the terminal control unit 30. The BLE communication unit 34 receives data transmitted from the vehicle Hv and provides the data to the terminal control unit 30, while modulating data input thereto from the terminal control unit 30 and transmitting the data to the vehicle Hv.

The cellular communication unit 35 is a communication module for connection to the Internet via a wireless base station, and is configured to be able to perform wireless communication in compliance with a standard such as, e.g., 4G or 5G. The cellular communication unit 35 may receive a data package for, e.g., installing the digital key application 304 from a predetermined server. Note that the cellular communication unit 35 is an optional element, and may also be omitted. Alternatively, the mobile terminal 3 may also be configured to be able to access the Internet via a Wi-Fi line instead of the cellular line such as 4G or 5G.

The terminal control unit 30 is configured as a computer including, e.g., a processor 301, a RAM 302, a storage 303, and the like. The digital key application 304 is installed in the storage 303 or the like. In a storage 303, the key information is stored. Note that the digital key application 304 is an application for securely performing acquisition of the key information, storage thereof, authentication processing, and the like. The digital key application 304 is an optional element, and may also be omitted.

The terminal control unit 30 causes the BLE communication unit 34 to transmit the advertise signal at predetermined transmission intervals. Note that, in another mode, the mobile terminal 3 may also transmit the scan response on the basis of a request from the in-vehicle system 1, i.e., the scan request. When received data is input thereto from the BLE communication unit 34, the terminal control unit 30 generates a baseband signal equivalent to a response signal corresponding to the received data, and outputs the baseband signal to the BLE communication unit 34. For example, when the BLE communication unit 34 receives the challenge code, it uses a predetermined procedure/function on the basis of each of the challenge code and the key information to generate a response code. Then, the terminal control unit 30 outputs the baseband signal including the response code to the BLE communication unit 34. The baseband signal output from the terminal control unit 30 to the BLE communication unit 34 is modulated in the BLE communication unit 34, and transmitted as a wireless signal.

The terminal control unit 30 may also be configured not to return the response code during a downtime period set by the user. The configuration can reduce a risk of successful authentication in a situation where the user has no intention to use the vehicle Hv. The downtime period may be manually set by the user so as to correspond to a time period during which there is no possibility of using the vehicle Hv. For example, a period during which the user is sleeping or going to school or work or the like may be set as the downtime period. The downtime period may also be automatically registered on the basis of user behavior history information. A user behavior history may be specified on the basis of position information of the mobile terminal 3 such as a GPS.

The terminal control unit 30 may also be configured not to return the response code when the mobile terminal 3 is stationary for a given time period or longer. Whether or not the mobile terminal 3 is stationary may be specified on the basis of, e.g., an output of an acceleration sensor or a gyro sensor included in the mobile terminal 3.

Note that, when the operation of the BLE communication unit 34 can be controlled on an application-by-application basis, the terminal control unit 30 may also stop advertise transmission during the downtime period. Such a configuration can reduce power consumption due to unnecessary advertising. Likewise, it may also be possible to stop the advertise transmission on the basis of the fact that the mobile terminal 3 is stationary for a given time period or longer. In addition, the terminal control unit 30 may also be configured to inhibit the communication connection to the in-vehicle system 1 on the basis of the downtime period or the fact that it is stationary for a given time period or longer.

### <Function of Smart ECU 4>

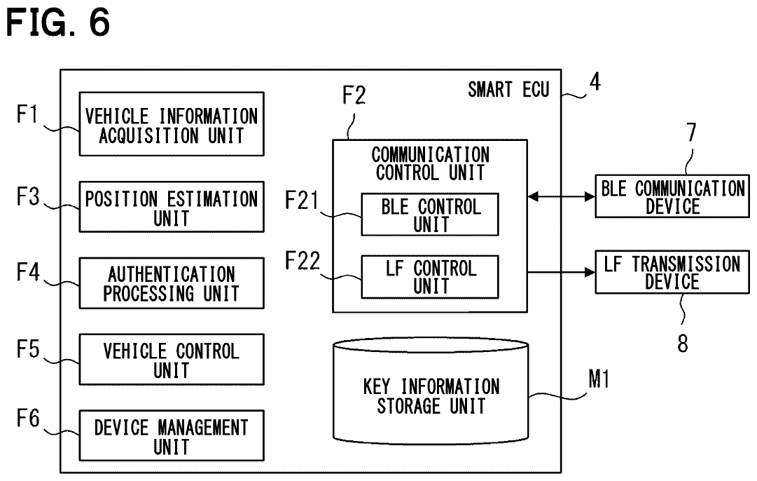

Using FIG. 6, a description will be given herein of the functions and operation of the smart ECU 4. The smart ECU 4 executes a program stored in the storage 43 to provide functions corresponding to various functional blocks illustrated in FIG. 6. In other words, the smart ECU 4 includes, as the functional blocks, a vehicle information acquisition unit F1, the communication control unit F2, a position estimation unit F3, an authentication processing unit F4, a vehicle control unit F5, and a device management unit F6. The communication control unit F2 includes, as sub-functional units, a BLE control unit F21 and an LF control unit F22. The BLE control unit F21 corresponds to the first communication control unit, and the LF control unit F22 corresponds to the second communication control unit. The smart ECU 4 includes a key information storage unit M1.

The key information storage unit M1 is a storage medium for storing information on the smart key 2 and the mobile terminal 3 each usable as the electronic key of the vehicle Hv. In the key information storage unit M1, information on at least one key device Kd is stored. In the key information storage unit M1, the key information of the individual key devices Kd is stored in association with the key IDs, the device IDs, the user IDs, device type information, and the like. The user IDs are identifiers for identifying a plurality of the users, and set for the individual users. The device type indicates the smart key 2 or the mobile terminal 3. The key information may also be stored in association with information such as validity periods, authorities, and the like. Additionally, the key information may also be associated with user personal setting information with respect to a vehicle interior environment, such as a sheet position.

The key information storage unit M1 is implemented using a part of a storage region included in the storage 43. Note that the key information storage unit M1 may also be implemented using a nonvolatile storage medium physically independent of the storage 43. The key information storage unit M1 is configured to be able to allow the processor 41 to perform writing, reading, deletion, or the like of data thereto.

The vehicle information acquisition unit F1 acquires various vehicle information indicating a state of the vehicle Hv from the sensors, the ECUs, the switches, and the like mounted in the vehicle Hv. For example, a state of a vehicle power source, an open/closed state of each of the doors, a locked/unlocked state of each of the doors, the presence or absence of pressing of each of the door buttons 5, the presence or absence of pressing of the start button 6, a shift position, and the like correspond to the vehicle information. The state of the vehicle power source includes whether or not the driving power source is ON. The types of the vehicle information are not limited to those described above. Signals indicating an output value from a brake sensor that detects an amount of stepping on a brake pedal/a stepping force applied thereon and an operating state of a parking brake may also be included in the vehicle information.

The vehicle information acquisition unit F1 specifies a current state of the vehicle Hv on the basis of the various information described above. For example, when the engine is OFF and all the doors are locked, the vehicle information acquisition unit F1 determines that the vehicle Hv is parked. Conditions for determining that the vehicle Hv is parked may be designed appropriately, and various determination conditions can be applied thereto. Note that acquisition of electric signals from the door buttons 5 and the start button 6 corresponds to detection of user operations performed on these buttons. The vehicle information acquisition unit F1 detects user operations performed on the vehicle Hv, such as opening/closing of the doors, pressing of the door buttons 5, pressing of the start button 6, and opening/closing of the doors.

The communication control unit F2 controls operations of the BLE communication devices 7 and the LF transmission devices 8. A configuration that controls the BLE communication devices 7 corresponds to the BLE control unit F21, while a configuration that controls the LF transmission devices 8 corresponds to the LF control unit F22. The communication control unit F2 uses the BLE communication device 7x to perform data communication with the key device Kd. For example, the communication control unit F2 generates data addressed to the key device Kd to which the communication control unit F2 is connected for communication and outputs the data to the BLE communication device 7x. Thus, the BLE communication device 7x is caused to transmit a signal corresponding to intended data as a radio wave. In addition, the communication control unit F2 receives data from the key device Kd which is received by the BLE communication device 7x. In the present embodiment, in a more preferable mode, data communication between the smart ECU 4 and the key device Kd is performed by being encrypted.

The communication control unit F2 recognizes that the user is present around the vehicle Hv on the basis of reception of a BLE signal transmitted from the key device Kd. In addition, the communication control unit F2 acquires the device ID of a communication connection partner from the BLE communication device 7x. Even when the vehicle Hv is a vehicle shared among the plurality of users, the smart ECU 4 specifies the user present around the vehicle Hv on the basis of the ID of the key device Kd to which the BLE communication device 7 is connected for communication.

The communication control unit F2 controls the operation of each of the LF transmission devices 8 on the basis of information on the position of the mobile terminal 3 estimated by the position estimation unit F3 described later. In other words, the communication control unit F2 controls the LF transmission devices 8 in different modes according to the position of the mobile terminal 3. Details of the modes in which the LF transmission devices 8 are controlled will be separately described later.

In addition, the communication control unit F2 acquires data indicating a status of signal reception from the key device Kd from each of the plurality of BLE communication devices 7. For example, the communication control unit F2 acquires, as the status of the signal reception from the key device Kd, data indicating a reception strength and a phase at each frequency. The communication control unit F2 also provides data indicating the status of the signal reception from the key device Kd in each of the BLE communication devices 7 to another function/circuit module such as the position estimation unit F3.

Note that the communication control unit F2 may also acquire a signal arrival direction as information indicating the status of the signal reception from the key device Kd. Estimation of the signal arrival direction can be performed by various methods such as, e.g., a MUSIC method and an ESPRIT method. Data acquisition in the present disclosure includes not only a mode in which data is input from the outside, but also generation/detection of the data by an internal arithmetic operation. The reception strength, the phase, the arrival direction, and the like can be referred to as reception features.

The position estimation unit F3 estimates the position of the key device Kd on the basis of the status of the signal reception from the key device Kd in each of the BLE communication devices 7. In the present disclosure, the position of the key device Kd may be referred to also as a device position. Since the key device Kd corresponds to the user, estimation of the device position corresponds to estimation of the position of the user.

The position estimation unit F3 sequentially performs processing of estimating the device position at predetermined estimation intervals while the BLE communication device 7x is connected for communication to at least one key device Kd. The estimation intervals can be 100 milliseconds. The estimation intervals may also be 200 milliseconds, 150 milliseconds, or the like. The position estimation processing by the position estimation unit F3 will be separately described later.

Note that the position estimation unit F3 may also be configured to estimate, when receiving a signal from the key device Kd, a position of the source on the basis of the received signal even though the position estimation unit F3 is not connected for communication. When receiving signals from the plurality of key devices Kd, the position estimation unit F3 may perform processing of estimating positions on a plurality of the key devices Kd in parallel. The position estimation unit F3 may determine not only positions of terminals registered as the key devices Kd, but also a position of an unregistered terminal.

The authentication processing unit F4 cooperates with the BLE communication device 7x to perform processing of confirming (i.e., authenticating) that the communication partner is the key device Kd. Communication for the authentication is performed by being encrypted. The authentication processing may be performed appropriately by using various methods such as the challenge-response method. For example, the authentication processing unit F4 transmits a predetermined/randomly generated challenge code toward the key device Kd. The authentication processing unit F4 uses, for the challenge code, the key information according to the device ID/key ID of the communication partner to generate a verification code by a predetermined procedure. Then, the authentication processing unit F4 compares a response code returned from the communication partner to the verification code to determine that the authentication is successful on the basis of a match between the two codes.

Timing at which the authentication unit F4 performs the authentication processing can be, e.g., timing at which communication connection between the BLE communication device 7 and the key device Kd is established. The authentication processing unit F4 may also be configured to perform the authentication processing at predetermined periods while the BLE communication device 7 and the key device Kd are connected to each other for communication. The authentication processing unit F4 may also be configured to be triggered by a predetermined user operation performed on the vehicle Hv to perform communication for the authentication processing in such a case where the start button 6 is pressed by the user or where the door is opened/closed.

The vehicle control unit F5 is configured to perform vehicle control according to the device position and the state of the vehicle Hv in cooperation with the body ECU 12 or the like on the condition that authentication of the key device Kd by the authentication processing unit F4 is successful. The state of the vehicle Hv is determined by the vehicle information acquisition unit F1. The position of the key device Kd is determined by the position estimation unit F3. For example, when it has been determined by the position estimation unit F3 that the key device Kd is present in the vehicle interior and when pressing of the start button 6 by the user is detected, the vehicle control unit F5 starts the engine in cooperation with the power source ECU 11. The vehicle interior can be referred to as a passive start area.

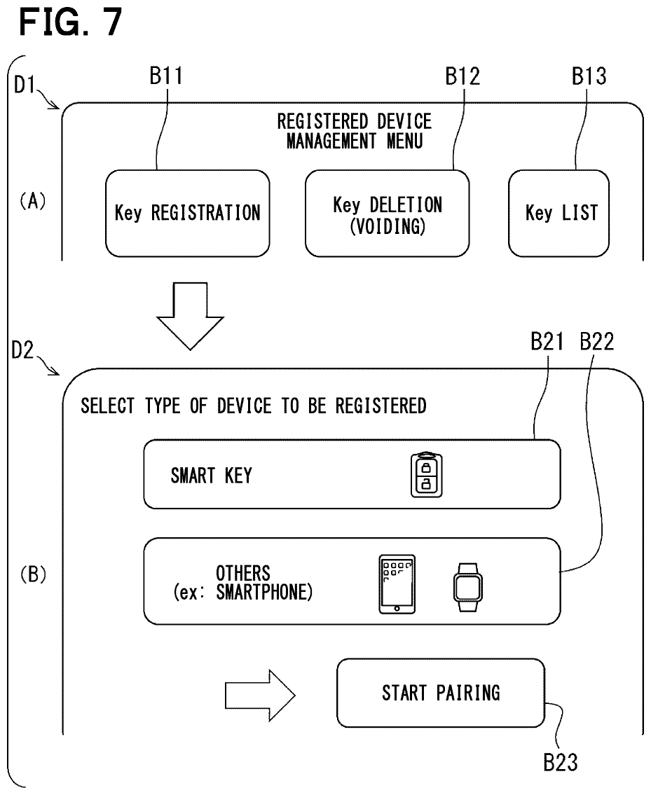

The device management unit F6 is the functional unit that manages a device registered as the key device Kd. The device management unit F6 registers/deletes the key device Kd on the basis of a user operation. The device management unit F6 displays a key device management screen D1 on the display 15 on the basis of, e.g., an operation signal input thereto from the input device 16. The key device management screen D1 may include a registration button B11, a deletion button B12, and a list display button B13 as illustrated in, e.g., FIG. 7(A). The registration button B11 is a button image for registering the key device Kd. The deletion button B12 is a button image for deleting the registered key device Kd. The list display button B13 is a button image displaying a list of the registered key devices Kd.

When detecting that, e.g., the registration button B11 is selected on the basis of an operation signal, as illustrated in FIG. 7(B), the device management unit F6 displays a device information input screen D2 for inputting a type or the like of a registration target device which is a device to be newly registered. As illustrated in, e.g., FIG. 7, the device information input screen D2 includes a smart key specification button B21 for inputting the fact that the device to be newly registered is the smart key 2 and a versatile terminal specification button B22 for inputting the fact that the device to be newly registered is another device. In addition, the device information input screen D2 may also include a pairing start button B23 for starting pairing or the like after the device type is selected. The device information input screen D2 corresponds to an example of a device registration screen.

The device management unit F6 acquires the type of the device to be registered at the time of device registration to be able to acquire whether or not the smart key 2 has been registered as the key device Kd. The type information of the key device Kd acquired by the device management unit F6 is stored, in the key information storage unit M1, in association with the key information.

The smart key 2 may be registered as the key device Kd at, e.g., a dealer shop or the like. However, whether or not the smart key 2 is to be registered as the key device Kd is an optional element. The smart key 2 registered as the key device Kd may also be deregistered/disabled by a user operation. It may also be possible that, in response to a request by the user/owner, only the mobile terminal 3 is registered as the key device Kd in the key information storage unit M1. The terminal registered as the effective key device Kd in the key information storage unit M1 is referred to also as a daily-use device. The daily-use device refers to the key device Kd to be used in daily life.

### <Determination Method of Device Position>

A description is given herein of a method of estimating the position of the key device Kd. As the position estimation method, various methods can be used. Determination of the device position, which is the position of the key device Kd, can be divided into, e.g., locking/unlocking area determination processing of determining whether or not the key device Kd is present in the locking/unlocking area Lx and vehicle inside/outside determination processing of determining whether or not the key device Kd is present in the vehicle interior. In the present disclosure, determination of whether or not the key device Kd is present in the locking/unlocking area Lx is referred to also as locking/unlocking area determination. In the present disclosure, determination of whether or not the key device Kd is present in the vehicle interior is referred to also as vehicle inside/outside determination.

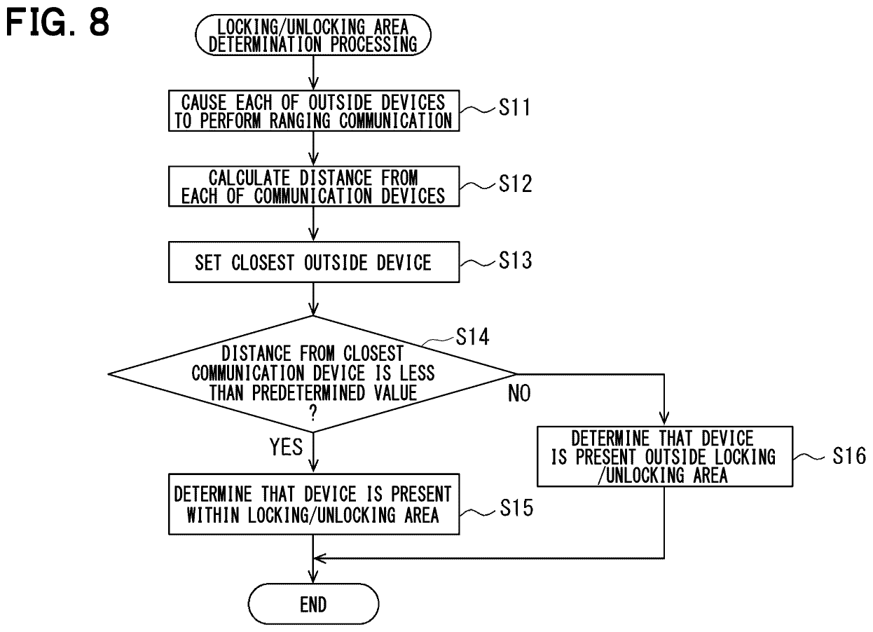

First, using FIG. 8, a description will be given of the locking/unlocking area determination processing. By way of example, the locking/unlocking area Lx determination processing includes Steps S11 to S16. The locking/unlocking area Lx determination processing may be performed on the condition that, e.g., as a result of the vehicle inside/outside determination processing to be subsequently described, the key device Kd is determined to be not present in the vehicle interior, i.e., to be present outside the vehicle interior. The locking/unlocking area Lx determination processing may be performed at predetermined periods such as, e.g., every 200 milliseconds on the condition that there is the key device Kd connected for communication. Note that any flow chart in the present disclosure is an example and is not limited to that in FIG. 8, and the number of steps included in each flow chart and a processing order can be changed as appropriate.

Step S11 is a step of causing each of the outdoor devices to perform ranging communication with the key device Kd. The ranging communication is communication for measuring a distance from each of the BLE communication devices 7 to the key device Kd. A device distance, which is the distance from the BLE communication device 7 to the key device Kd, corresponds to a signal flight time (ToF: Time of Flight) of a signal. Specification of the device distance is equivalent to specification of the ToF. The device distance is calculated on the basis of a two-frequency phase difference or a round trip time (RTT: Round-Trip Time). By way of example, the device distance is calculated using the two-frequency phase difference for each combination of a plurality of frequencies, i.e., multi-frequency phase difference information.

The two-frequency phase difference is a difference between transmission-reception phase differences observed at two frequencies different from each other. Each of the transmission-reception phase differences is a phase angle of a received CW signal with respect to a transmitted CW signal. For example, each of the outdoor devices transmits/receives the CW signal to/from the key device Kd as the ranging communication to specify the transmission-reception phase difference at one frequency. As a method of calculating the transmission-reception phase differences at the individual frequencies, various algorithms can be incorporated. In a configuration using the multi-frequency phase difference as a material for calculating the device distance, the ranging communication can specifically be considered to be communication for specifying the transmission-reception phase difference at each frequency.

In the BLE communication, a frequency to be used changes with time as a result of frequency hopping. As the ranging communication at each frequency, the CW signal is transmitted/received to allow the transmission-reception phase differences at the plurality of frequencies to be collected. The processor 41 serving as a ToF-related-value acquisition unit F23 combines the respective transmission-reception phase differences at the individual frequencies observed by the same outdoor device to calculate the two-frequency phase difference at each combination of frequencies. The processor 41 performs processing of calculating the two-frequency phase difference for each of the outdoor devices to acquire another-frequency phase difference information in each of the outdoor devices. Note that the calculation of the transmission-reception phase difference may also be performed by the processor 41 on the basis of reception phase information provided from each of the communication microcomputers 74.

Step S12 is a step of calculating a distance from each of the outdoor devices to the key device Kd. The position estimation unit F3 calculates the distance from each of the outdoor devices to the key device Kd on the basis of the multi-frequency phase difference information of each of the outdoor devices collected in Step S11. Note that the processing of calculating the device distance may also be performed not by the smart ECU 4, but by the communication microcomputer 74 of each of the BLE communication devices 7. It may also be possible that the communication microcomputer 74 has any of the functions of the position estimation unit F3.

When it is assumed that the two-frequency phase difference is Δφ, a propagation speed of a radio wave is C (3×10\hat{ }8 m/sec), a difference between two frequencies is Δf, and a distance to the key device Kd is L, a relationship given by L=C·Δφ/(2πΔf) is provided. However, the two-frequency phase difference at a pair of frequencies may include an error resulting from a multi-path or the like. In addition, a degree of influence of the multi-path differs from one frequency to another. Due to such circumstances, the processor 41 specifies the device distance on the basis of two or more pairs of two-frequency phase differences, i.e., transmission-reception phase differences at three or more frequencies. From the configuration, an effect of enhancing ranging accuracy can be expected.

Needless to say, the position estimation unit F3 may also calculate the device distance on the basis of the RTT instead of the two-frequency phase difference. The RTT is a time period from transmission of a response request signal to reception of a response signal. When the RTT is used, the device distance to each of the outdoor devices can be specified by individual transmission/reception of a ranging signal by each of the outdoor devices to/from the key device Kd.

In Step S13, on the basis of a result of Step S12, the closest outdoor device, which is the BLE communication device 7 closest to the key device Kd, is specified. In Step S14, it is determined whether or not a distance from the closest outdoor device to the key device Kd is less than a predetermined value. As the predetermined value to be used in determination processing in Step S14, e.g., the operation distance mentioned above can be used. When the distance from the closest outdoor device to the key device Kd is less than the operation distance, a flow moves to Step S15, and it is determined that the key device Kd is present within the locking/unlocking area Lx. Meanwhile, when the distance from the closest outdoor device to the key device Kd is not less than the operation distance, the flow advances to Step S16, and it is determined that the key device Kd is outside the locking/unlocking area Lx. It can be understood that Step S14 is processing of determining whether or not a minimum value of respective distances observed for the plurality of BLE communication devices 7 in Step S12 is less than the operation distance.

Note that the position estimation unit F3 may also determine that the key device Kd is present within the locking/unlocking area Lx on the condition that not only the distance from the closest outdoor device to the key device Kd is less than the operation distance, but also the reception strength in the closest outdoor device is larger than the reception strength in the indoor device. The reception strength in the indoor device used herein may be a representative value (e.g., maximum value) of the reception strengths in the plurality of indoor devices, or may also be the reception strength in the indoor device closest to the closest outdoor device.

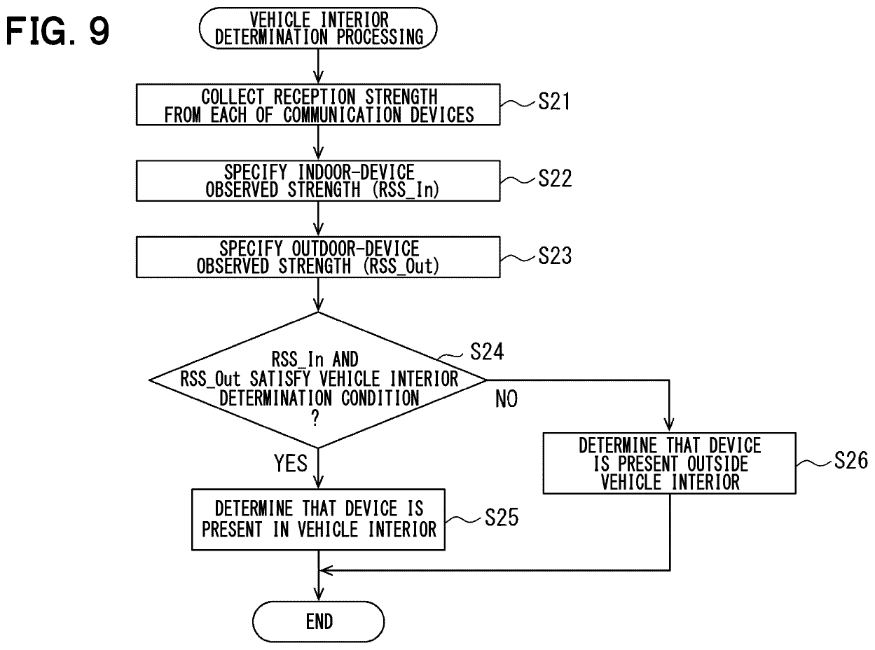

Next, using FIG. 9, a description will be given of the vehicle inside/outside determination processing. By way of example, the vehicle inside/outside determination processing includes Steps S21 to S26. Step S21 is a step of acquiring the reception strength from each of the BLE communication devices 7. The acquisition of the reception strength may be performed as necessary.

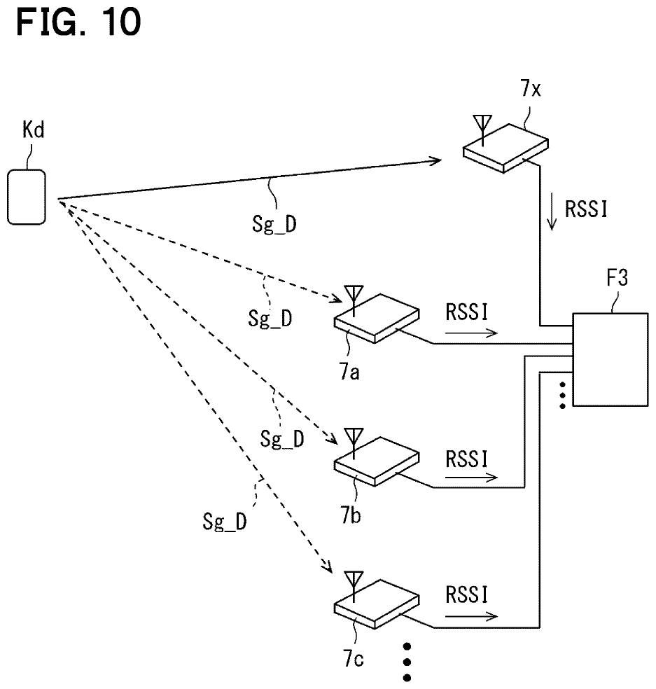

Note that, in specifying the reception strength of the signal from the key device Kd, it is not necessary for all the BLE communication devices 7 to be connected for communication to the key device Kd. As illustrated in FIG. 10, each of the BLE communication devices 7 except for the BLE communication device 7x serving as the representative device may also be configured to perform only observation of the reception strength of the signal from the key device Kd. Each of the BLE communication devices 7 other than the representative device is hereinafter referred to as the observation device. The observation device can be referred to as a listening device. The observation device corresponds to the BLE communication device 7 that performs only reception without performing signal transmission. Sg_D shown in FIG. 10 denotes a signal transmitted from the key device Kd to the BLE communication device 7x/the large number of unspecified BLE communication devices. Sg_D may be a data signal or the advertise. Sg_D may be a CW signal.

Note that, since the frequency hopping is performed during data communication, normally only the BLE communication device 7x connected for communication can capture the data signal from the key device Kd. Accordingly, the smart ECU 4 distributes the channel information and the device ID each acquired from the BLE communication device 7x serving as the representative device as reference information to each of the observation devices.

The channel information indicated by the reference information enables each of the observation devices to recognize reception of which one of the large number of channels that can be used in the BLE allows the signal from the key device Kd to be received. As a result, the observation device can detect and report the reception strength and the like of the signal from the key device Kd without being connected for communication. In addition, even when the signals from the plurality of devices are received by the observation devices, the device ID indicated by the reference information allows the observation devices to specify the device transmitting the signal the reception strength of which is to be reported to the smart ECU 4. Note that RSSI illustrated in FIG. 10 indicates the reception strength.

A method that thus uses some of the BLE communication devices 7 as the observation devices to determine the device position on the basis of reception statuses in the observation devices is referred to also as a sniffing method in the present disclosure. According to the sniffing method, the number of the BLE communication devices 7 to which the key device Kd is to be connected for communication can be reduced to at least 1, and therefore it is possible to reduce the power consumption in the key device Kd. In addition, according to the sniffing method, indexes indicating the distances from the plurality of BLE communication devices 7 to the key device Kd can be collected in parallel, and therefore it is possible to enhance system responsiveness to approach of the user carrying the key device Kd. Needless to say, in another mode, it may also be possible that each of the BLE communication devices 7 individually performs communication for ranging with the key device Kd and provide information such as the reception strength and the reception phase to the smart ECU 4.

Step S22 is a step of determining an indoor-device observed strength (RSS_In) on the basis of the reception strength of the signal from the key device Kd observed in at least one indoor device within a last given period of time. For example, the position estimation unit F3 calculates an individual strength representative value for each of the indoor devices as preparatory processing for determining the indoor-device observed strength. Then, the position estimation unit F3 uses, as the indoor-device observed strength, a maximum value of the individual strength representative values of the respective indoor devices.

The individual strength representative value is a value representatively indicating the reception strength of the signal from the key device Kd which has been observed in the single indoor device within the last predetermined period of time. By way of example, it is assumed herein that the individual strength representative value is an average value of the reception strengths within the last 100 milliseconds or 200 milliseconds. A reception strength sampling period for determining the one individual strength representative value or indoor-device observed strength can be changed as appropriate. Such an individual strength representative value corresponds to a moving average value of the reception strengths.

The individual strength representative vale may be calculated for one predetermined frequency, or may also be determined on the basis of the reception strengths at a plurality of frequencies. The representative value may also be a median value or a maximum value, not the average value. The representative value may also be an average value, a median value, or a maximum value of a population from which outliers have been removed. The outliers can be values more than twice or three times a standard deviation away from the average value or the median value of the original population. As methods of determining the outliers, various methods such as a Smirnov-Grubbs test or a Thompson method can be incorporated. Note that the individual strength representative value need not necessarily be determined on the basis of the observation values at a plurality of time points. The individual strength representative value may also be an observation value at any time point, e.g., an observation value of the latest reception strength.

Meanwhile, the indoor-device observed strength may also be determined by a method other than that described above. For example, it may also be possible to specify, according to the same method as in Steps S12 to S13, the closest indoor device that is the BLE communication device 7 closest to the key device Kd and use the individual strength representative value in the closest indoor device as the indoor-device observed strength. Note that the closest indoor device may also be the indoor device closest to the closest outdoor device. The processor 41 may also refer to the communication device setting data and use the indoor device located at a position closest to the closest outdoor device as the closest indoor device.

Step S23 is a step of determining an outdoor-device observed strength (RSS_Out) on the basis of the reception strength of the signal from the key device Kd observed in at least one outdoor device within a last given period of time. The method of determining the outdoor-device observed strength can be the same as the method of determining the indoor-device observed strength.

In Step S24, it is determined whether or not the indoor-device observed strength (RSS_In) and the outdoor-device observed strength (RSS_Out) satisfy a vehicle interior determination condition. The vehicle interior determination condition is a condition for determining that the key device Kd is present in the vehicle interior. For example, when an inside-outside difference value (ΔRSS) obtained by subtracting the indoor-device observed strength from the outdoor-device observed strength is larger than a predetermined difference threshold (ThGap), the position estimation unit F3 determines that the key device Kd is present in the vehicle interior (Step S25). In other words, when RSS_In-RSS_Out=ΔRSS>ThGap is satisfied, it is determined that the key device Kd is present inside the vehicle interior. Meanwhile, when the inside-outside difference value (ΔRSS) is equal to or less than the difference threshold, i.e., when ΔRSS≤ThGap is satisfied, the position estimation unit F3 determines that the key device Kd is present outside the vehicle interior (Step S26). The difference threshold is 10 dB, 20 dB, or the like. The difference threshold may be 0. A configuration in which the difference threshold is 0 corresponds to a configuration that determines that the key device Kd is present in the vehicle interior on the basis of the indoor-device observed strength which is larger than the outdoor-device observed strength.

The position estimation unit F3 may also determine that, even though ΔRSS≤ThGap is satisfied, when the indoor-device observed strength (RSS_In) is over a predetermined inside determination value (ThIn), the key device Kd is present in the vehicle interior. In other words, it may also be possible to determine that, when RSS_In>ThIn is satisfied, the key device Kd is present inside the vehicle interior irrespective of ΔRSS. The inside determination value (ThIn) used herein is a threshold for the indoor-device observed strength for determining that the key device Kd is present inside the vehicle interior. The inside determination value is designed appropriately through tests or the like. The inside determination value is set sufficiently large so as to be able to reduce a possibility of erroneous determination. For example, the inside determination value is set to a value smaller by about 10 dB than a maximum value of the indoor-device observed strength that may be observed when the key device Kd is present in the vehicle interior.

The position estimation unit F3 may also determine that, even though ΔRSS>ThGap is satisfied, when the outdoor-device observed strength (RSS_Out) is over a predetermined outside determination value (ThOut), the key device Kd is present outside the vehicle interior. In other words, it may also be possible to determine that, when RSS_Out>ThOut is satisfied, the key device Kd is present outside the vehicle interior irrespective of ΔRSS. The outside determination value (ThOut) used herein is a threshold for the outdoor-device observed strength for determining that the key device Kd is present outside the vehicle interior. The outside determination value is also designed appropriately through tests or the like. The outside determination value is set sufficiently large so as to be able to reduce the possibility of erroneous determination. For example, the outside determination value is set to a value smaller by about 10 dB than a maximum value of the outside-device observed strength that may be observed when the key device Kd is present within the locking/unlocking area Lx.

A result of the determination of the position of the key device Kd by the position estimation unit F3, i.e., device position information is stored in the RAM 42. Note that the device position information is used by reference by various programs/functional units.

In addition, the position estimation unit F3 sequentially stores even information on a distance between the closest outdoor device and the key device Kd specified by Steps S12 to S13 as the device information in the RAM 42. In other words, in the RAM 42, not only whether the key device Kd is present in the vehicle interior, within the locking/unlocking area Lx, or outside the locking/unlocking area Lx, but also information on a distance to the closest communication device may also be stored. The position estimation unit F3 may also store not only the information on the distance to the closest communication device, but also information on a distance to each of the other BLE communication devices in the RAM 42. Each data may be stored together with a time stamp indicating an acquisition time.

When the BLE communication device 7x receives signals from a plurality of the key devices Kd, the position estimation unit F3 specifies, for each of the key devices Kd, a relative position or distance with respect to the vehicle Hv. The position estimation unit F3 may determine whether the device is the smart key 2 or the mobile terminal 3 on the basis of the ID of the key device Kd connected for communication thereto or the like.

Furthermore, the position estimation unit F3 also determines in which one of a distant area, an intermediate region, a neighboring area, and the vehicle interior the mobile terminal 3 is present. The distant area refers to an area that is 5 m or more from the vehicle Hv, for example. The neighboring area refers to a range within 2 m from the vehicle Hv. The intermediate area refers to a range between the distant area and the neighboring area, i.e., at 2 m or more and less than 5 m from the vehicle Hv. Note that a mode in which an area outside the vehicle is divided can be changed as appropriate. The intermediate area may also be integrated with either one of the distant area and the neighboring area. Distances defining the neighboring area and the distant area may also be changed as appropriate. For example, the neighboring area may be defined to be within 1.5 m from the vehicle Hv, or may also be defined so as to match the locking/unlocking area Lx.

For example, when the mobile terminal 3 is not present in the vehicle and the mobile terminal 3 is present at a distance of less than 2 m from the closest outdoor device, the position estimation unit F3 considers that the mobile terminal 3 is present in the neighboring area on the basis of the device position information stored in the RAM 42. Meanwhile, in a situation where the mobile terminal 3 is present neither in the vehicle interior nor in the neighboring area, when the mobile terminal 3 is present at a distance of 2 m or more and less than 5 m from the closest outdoor device, the position estimation unit F3 considers that the mobile terminal 3 is present in the intermediate area. When the mobile terminal 3 is present in none of the vehicle interior, the neighboring area, and the intermediate area, the position estimation unit F3 determines that the mobile terminal 3 is present in the distant area. The position estimation unit F3 also considers that the mobile terminal 3 is present in the distant area when no signal is received from the mobile terminal 3.

### <Control Mode for LF Transmission Device>

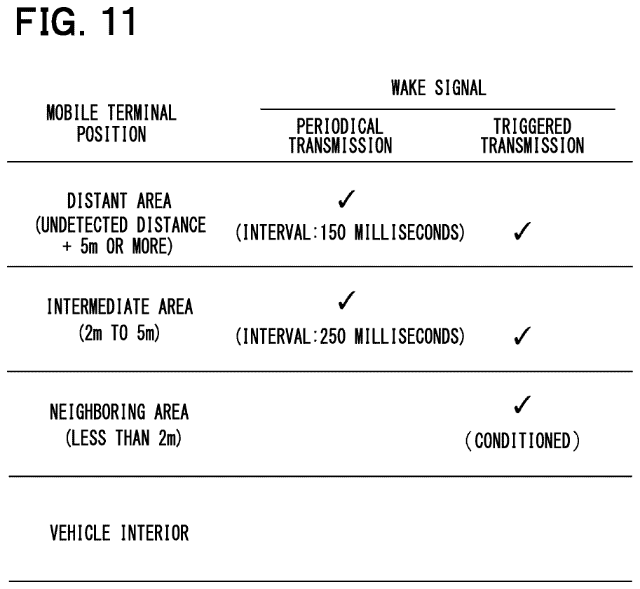

Using FIG. 11, a description will be given herein of a mode in which each of the LF transmission devices 8 is controlled by the communication control unit F2, specifically a mode in which transmission of the wake signal is controlled. The communication control unit F2 changes a control mode related to the transmission of the wake signal on the basis of the position of the mobile terminal 3 estimated by the position estimation unit F3. FIG. 11 illustrates an example thereof. Not transmitting the wake signal corresponds to not waking up the smart key 2. Therefore, changing the wake signal transmission control mode corresponds to switching between waking up the smart key 2 and not waking up the smart key 2. The transmission of the wake signal is performed on the basis of no connection for communication to the smart key 2. Hereinafter, it is preferable to assume that the mobile terminal 3 is the mobile terminal 3 that has already succeeded in authentication processing using a challenge response or the like.

By way of example, the communication control unit F2 changes herein the wake signal transmission mode in separate cases where the mobile terminal 3 is present in the distant area, where the mobile terminal 3 is present in the intermediate area, where the mobile terminal 3 is present in the neighboring area, and where the mobile terminal 3 is present in the vehicle interior.

First, when it is determined that the mobile terminal 3 is present in the distant area, the communication control unit F2 periodically transmits the wake signal at predetermined polling intervals. The polling intervals are 100 milliseconds, 150 milliseconds, 200 milliseconds, or the like. The communication control unit F2 transmits the wake signal even when sensing a predetermined user operation. The user operation mentioned herein refers to a predetermined operating behavior of the user for using the vehicle Hv, such as, e.g., pressing of any of the door buttons 5 or pressing of the start button 6. In the present disclosure, transmission of the wake signal on the basis of sensing of the user operation performed on the door button 5, the start button 6, a touch sensor, or the like is referred to also as triggered transmission.

With the configuration described above, even when the user carrying only the smart key 2 has approached the vehicle Hv without carrying the mobile terminal 3, it is possible to swiftly shift the smart key 2 to the active mode and perform authentication processing by the BLE communication. Note that the user carrying only the smart key 2 refers to the user carrying the smart key 2, but not carrying the mobile terminal 3 and, needless to say, the user may also carry an object other than the mobile terminal 3 such as a bag or an umbrella.

When it is determined that the mobile terminal 3 is present in the intermediate area, the communication control unit F2 transmits the wake signal at the predetermined polling intervals. In addition, even in a situation where it is determined that the mobile terminal 3 is present in the intermediate area, the communication control unit F2 performs the triggered transmission. The fact that the door button 5 or the like is pressed even though the mobile terminal 3 is still 2 m or more away from the vehicle Hv indicates the possibility that another user carrying only the smart key 2 is present around the vehicle Hv other than the user carrying the mobile terminal 3. Even in a situation where the presence of the mobile terminal 3 in the intermediate area has been sensed, a configuration which performs the triggered transmission can reduce a risk that the in-vehicle system 1 has not responded to a vehicle operation by the authorized user carrying only the smart key 2 or has returned a delayed response.

Note that the polling intervals when the mobile terminal 3 is in the intermediate area may be the same as or different from the polling intervals when the mobile terminal 3 is in the distant area. From a viewpoint of reducing battery consumption of the smart key 2, if both of the smart key 2 and the mobile terminal 3 are present around the vehicle, it is preferable to preferentially use, as a communication partner, the mobile terminal 3. As the polling interval for the wake signal is set longer, the smart key 2 is less responsive. Under such circumstances, when the mobile terminal 3 is present in the intermediate area, the polling interval may also be set longer by a predetermined amount (e.g., 200 milliseconds) than that when the mobile terminal 3 is present in the distant area. According to this control mode, it is possible to reduce the possibility of unnecessary waking up of the smart key 2 and consequently power consumption of the smart key 2.

When it is determined that the mobile terminal 3 is present in the neighboring area, the communication control unit F2 stops the periodic transmission of the wake signal. In addition, in a situation where it is determined that the mobile terminal 3 is present in the neighboring area, the communication control unit F2 performs the triggered transmission only when a specified transmission condition is satisfied.

For example, the communication control unit F2 performs the triggered transmission on the condition that, in the situation where the mobile terminal 3 is determined to be present in the neighboring area, there is no match between the position of the mobile terminal 3 and an operation button position. In a situation where the mobile terminal 3 is determined to be present in the neighboring area, the communication control unit F2 prevents the wake signal from being transmitted when there is a match between the position of the mobile terminal 3 and the operation button position. The operation button position indicates the position of the button pressed by the user. Note that, when a touch sensor is used appropriately instead of the button, the operation button position can be read as a touch position. The operation button position and the touch position are included in a concept of an operation member position.

To a case where there is no match between the position of the mobile terminal 3 and the operation button position, a case where the door button 5 for the driver seat is pressed in a situation where the mobile terminal 3 is at a position away from the driver seat such as, e.g., in the vicinity of the front passenger seat or the trunk corresponds. In addition, a case where the start button 6 is pressed in a situation where the mobile terminal 3 is determined to be present outside the vehicle interior may also correspond to the case where there is no match between the position of the mobile terminal 3 and the operation button position. In a situation where the mobile terminal 3 is determined to be present in the locking/unlocking area Lx on the front passenger seat side, when the pressing of the door button 5 for the driver seat is sensed, the communication control unit F2 causes the LF transmission device 8 to transmit the wake signal.

With the configuration described above, when there is a match between the operation button position and the position of the mobile terminal 3, the smart key 2 is not woken up. Accordingly, it is possible to reduce the power consumption of the smart key 2. Meanwhile, when there is no match between the operation button position and the position of the mobile terminal 3, the wake signal is transmitted, and accordingly a quick response can be returned even to the pressing of the button by the user carrying only the smart key 2. In addition, with the configuration described above, it is possible specify even the presence of the user carrying only the smart key 2 in addition to the user corresponding to the detected mobile terminal 3. As a result, it is possible to accurately specify a personal composition of passengers, the user who has the role of the driver, and the like.

Finally, when it is determined that the mobile terminal 3 is present in the vehicle interior, the communication control unit F2 stops the periodic transmission of the wake signal and the triggered transmission. Note that the mode in which the transmission of the wake signal is controlled may be the same when the mobile terminal 3 is present in the neighboring area and when the mobile terminal 3 is in the vehicle. For example, even when the mobile terminal 3 is present in the vehicle, the triggered transmission may also be performed under a predetermined condition. With this configuration, it is possible to reduce a risk that, due to unsuccessful authentication of the mobile terminal 3 or the like, the vehicle Hv cannot be used. Meanwhile, when the mobile terminal 3 is present in the neighboring area or in the vehicle interior, the transmission of the wake signal may also be totally stopped.

### <Connection-Related Processing>

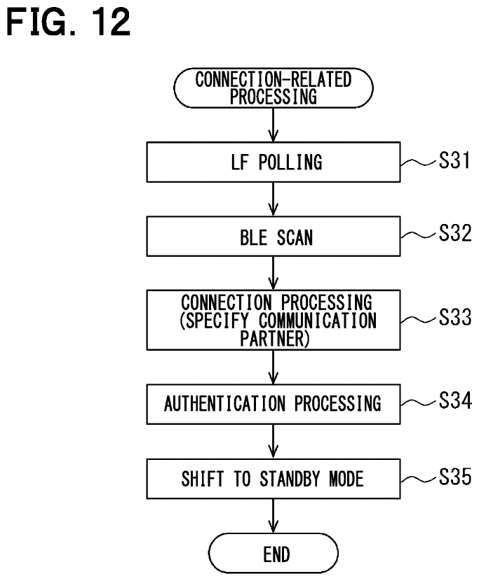

Using a flow chart illustrated in FIG. 12, a description will be given herein of connection-related processing. The connection-related processing is processing for providing connection for communication to the key device Kd approaching the vehicle Hv together with the user. The connection-related processing is performed at predetermined scan intervals in a state where, e.g., the vehicle Hv is parked. The scan intervals may be set to 100 milliseconds, 200 milliseconds, or the like. The connection-related processing includes Steps S31 to S35. The connection-related processing is performed by the processor 41 in cooperation with the BLE communication device 7x and the LF transmission device 8.

First, in Step S31, the communication control unit F2 causes the LF transmission device 8 to transmit the wake signal. As a result, if the smart key 2 is present around the vehicle, it is possible to cause the smart key 2 to shift to a state where the BLE communication is possible. However, as described above, when the presence of the mobile terminal 3 in the neighboring area has been sensed successfully as a result of performing the present processing once, the transmission of the wake signal by Step S31 may be omitted.

In Step S32, the communication control unit F2 sets the BLE communication device 7x in a standby state, and cause retrieval (so-called scanning) of the key device Kd to be performed. The standby state mentioned herein refers to a state where the advertise signal can be received. As a result of the scanning in Step S32, when no key device Kd is detected, the present flow is ended by omitting the processing including and subsequent to S33.

In Step S33, the BLE communication device 7x is caused to be connected for communication to the key device Kd detected by the scanning in Step S32. The connection for communication may be performed by exchanging a transmitted connection request and a response thereto. The processor 41 specifies the communication partner on the basis of source information or the like included in the advertise signal or the like. A detailed sequence related to the scanning, the communication connection, and starting of encrypted communication may appropriately be implemented on the basis of the BLE standard.

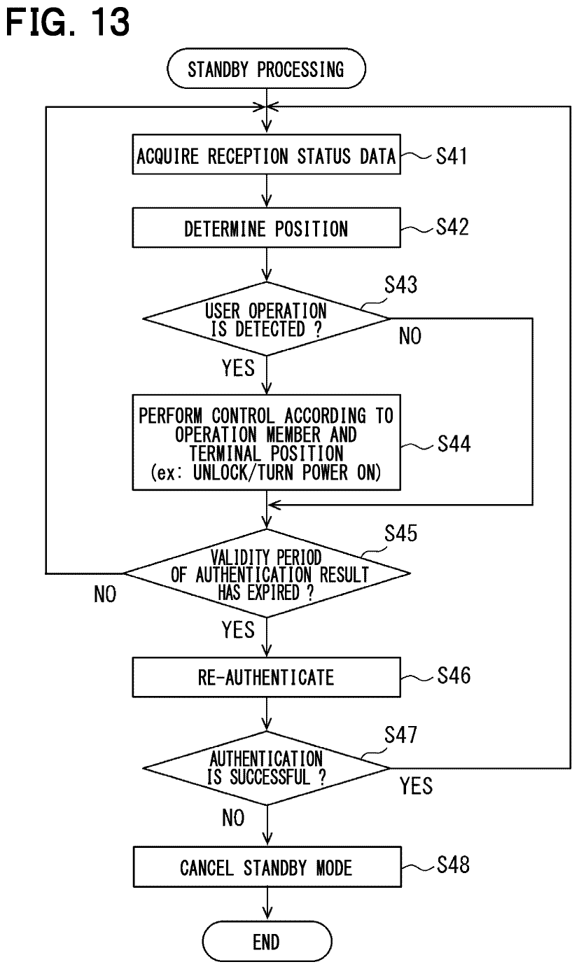

In Step S34, using, e.g., the challenge code and the key information of the communication partner stored in the key information storage unit M1, processing of authenticating the key device Kd is performed. As the challenge code, a random number of a predetermined length generated using a random number table or the like can be used. When the authentication is successful, a flow moves to Step S35 to shift to a standby mode. The standby mode corresponds to a state where, as will be separately described using FIG. 13, unlocking/locking, ON/OFF switching of the driving power source, or the like can be performed on the basis of the user operation performed on the door button 5 or the like. The standby mode corresponds to a state where the processor 41 recognizes that the key device Kd is present in the periphery of the vehicle on one side surface. The periphery of the vehicle also includes the vehicle interior.

In the present embodiment, by way of example, a validity period is set for a result of determination of successful authentication. When the validity period has expired, re-authentication is performed. Within the validity period, the authentication processing can be omitted, and accordingly power consumption in the key device Kd and the smart ECU 4 can be reduced. In addition, since the authentication processing is performed for each validity period, it is possible to reduce a risk of unauthenticated use of the vehicle Hv. The validity period may also be changed depending on a scene, such as whether or not the vehicle is driving. Since a possibility that the key device Kd moves to the outside of the vehicle interior during driving is low, the validity period during the driving may also be set longer by a predetermined amount than that during a vehicle stop. For example, while the validity period during the vehicle stop may be set to 1 second, 3 seconds, 5 seconds, or the like, the validity period during running may be set to 10 seconds, 30 seconds, or the like. Alternatively, the authentication processing unit F4 may also be configured to perform the authentication processing again when sensing a predetermined event, such as opening/closing of the door, even though the validity period has not expired. Note that the smart ECU 4 may also be configured so as to perform the authentication processing on each operation or at each event without holding a successful authentication state.

Meanwhile, when the authentication fails, the authentication processing may also be performed again or in-vehicle equipment may also be operated so as to allow the user to recognize the unsuccessful authentication. For example, when the authentication is unsuccessful, it may be possible to display a predetermined failed authentication image on the display 15 or light a lighting device provided in a side mirror or the like in a predetermined pattern. When the communication partner is the mobile terminal 3, a predetermined control signal is transmitted to cause the display 31 to display the failed authentication screen. The unsuccessful authentication may also be represented by a color of light emitted from a welcome light that emits the light toward a road surface around the door.

### <Operation During Standby Mode>

Using a flow chart illustrated in FIG. 13, a description will be given of an operation of the smart ECU 4 during the standby mode. During the standby mode, the processor 41 sequentially performs Steps S41 to S48 illustrated in FIG. 13 by way of example.

During the standby mode, as in Step S41, the processor 41 sequentially acquires, from each of the BLE communication devices 7, position estimation information which is information for specifying the position of the key device Kd. Position estimation information is a reception strength. The reception phase can also be included in the position estimation information. When it is determined that the key device Kd is present outside the vehicle interior, the processor 41 may acquire, from each of the outdoor devices, the two-frequency phase difference at each combination of frequencies, the RTT, or the like as the position estimation information. A ToF-related value corresponds to a subordinate concept of the position estimation information.

Step S42 is a step of determining the position of the key device Kd on the basis of the position estimation information acquired by the processor 41 (position estimation unit F3) from each of the BLE communication devices 7 in Step S41. Specifically, when the key device Kd is in the vehicle interior or outside the vehicle interior, it is determined whether or not the key device Kd is within the locking/unlocking area Lx. When the key device Kd is present within the locking/unlocking area Lx, the processor 41 specifies, according to the ID of the closest communication device, in which one of the right area LxR, the left area LxL, and the back area LxB the key device Kd is present.

Step S43 is a step in which the processor 41 determines whether or not a user operation has been performed on the basis of a signal from any of the door buttons 5, the start button 6, a curtesy switch, or the like. When a signal corresponding to the user operation is input thereto, the processor 41 performs, as in Step S44, vehicle control according to the member operated by the user, the device position, and the state of the vehicle Hv. For example, in a state where the vehicle Hv is locked, when it is determined that the operation member is the door button 5 and the device position is also within the locking/unlocking area Lx, the processor 41 (vehicle control unit F5) unlocks the door. Alternatively, when it is determined that the operation member is the start button 6 and the device position is determined to be in the vehicle interior, the processor 41 sets the driving power source to the ON state. Still alternatively, when it is determined that the vehicle Hv is unlocked, a shift position is set to a parking or neutral position, the operation member is the door button 5, and the device position is within the locking/unlocking area Lx, the processor 41 locks the door.

Step S45 determines whether or not the validity period of the authentication result has expired, i.e., whether or not a predetermined time period or longer has elapsed since the successful authentication was determined in S34 or Step S46 described later. When the predetermined time period has not elapsed from the final determination of the successful authentication, i.e., the validity period has not expired, a flow returns to Step S41. Meanwhile, when the predetermined time period has elapsed from the final determination of the successful authentication, the processor 41 performs, as in Step S46, communication for authenticating the key device Kd again. In other words, the processor 41 performs re-authentication processing.

Then, when the successful authentication is determined as a result of the re-authentication processing in Step S46, the standby mode is continued. In other words, the processing including and subsequent to Step S41 is sequentially performed. Meanwhile, when the authentication has failed, the processor 41 cancels, as in Step S48, the standby mode. Note that the standby mode may also be cancelled on the basis of the fact that the authentication processing has consecutively failed a prescribed number of times. The processor 41 may also end the standby mode not only when the authentication has failed, but also when it is sensed that the key device Kd has left a predetermined authenticated state maintenance area. Ending the standby mode corresponds to discarding an authentication result. The authenticated state maintenance area may be set in, e.g., a region where the vehicle interior and the locking/unlocking area Lx are integrated with each other.

<Operation Response when Device is Unsensed>

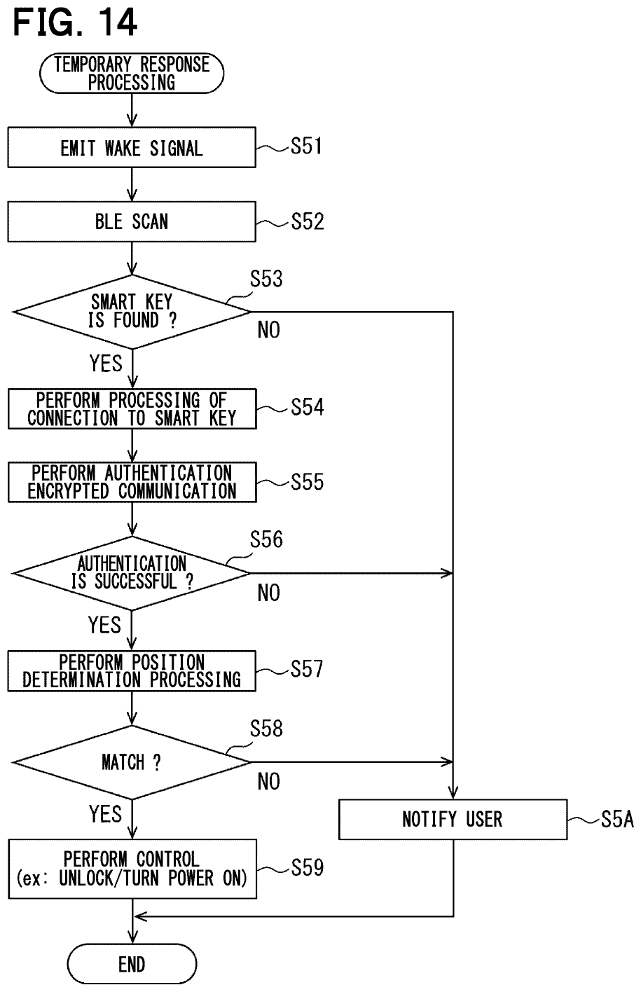

Using a flow chart illustrated in FIG. 14, a description will be given of temporary response processing to be performed by the smart ECU 4 when a user operation performed on the door button 5 or the like is sensed in a state where it is not determined that the key device Kd is present in the locking/unlocking area Lx or in the vehicle interior. Note that the smart ECU 4 may also perform the temporary response processing on the condition that there is no match between the device position and the position of the button operated by the user. The temporary response processing is processing mainly corresponding to a vehicle operation performed by the user carrying only the smart key 2. By way of example, the temporary response processing includes Steps S51 to S5A.

Step S51 is a step in which the processor 41 serving as the communication control unit F2 cooperates with the LF transmission device 8 to cause the LF transmission device 8 to transmit the wake signal. Step S52 is a step of performing scanning in the same manner as in Step S32. When the smart key 2 registered in advance is detected (YES in Step S53), the communication control unit F2 causes, as in Step S54, the BLE communication device 7x to be connected for communication thereto.

In Step S55, the authentication processing unit F4 performs authentication communication with the smart key 2, e.g., transmission/reception of a challenge/response code by encrypted communication using the BLE communication device 7x. In other words, Step S55 is a step in which the processor 41 performs the authentication processing. When the authentication processing is successful (Yes in Step S56), the position estimation unit F3 performs position determination processing as in Step S57. As the position determination processing, the position estimation unit F3 may also perform the vehicle inside/outside determination processing first and appropriately perform the locking/unlocking area determination processing on the basis of a result thereof. However, when it is obvious that the smart key 2 is not present in the vehicle such as when the vehicle Hv is in a parked state, the position estimation unit F3 may also omit the vehicle inside/outside determination processing and perform only the locking/unlocking area determination processing.

Step S58 determines whether or not there is a match between the operation button position which is the position of the button on which the user operation that triggered the present flow was performed and the position of the smart key 2 determined in Step S57. For example, a case where the operation button is the door button 5 for the driver seat and the position of the smart key 2 is in the right area LxR or the like corresponds to a case where there is a match between the two positions.

In the case where there is a match between the operation button position and the position of the smart key 2 (YES in Step S58), the vehicle control unit F5 performs vehicle control according to details of an operation or the like, e.g., unlocking of the door (Step S59). Meanwhile, in a case where there is no match between the operation button position and the position of the smart key 2, Step S5A is performed. Note that, when the authentication processing in Step S56 fails, even when the smart key 2 is not found in Step S53 also, the processor 41 performs Step S5A.

Step S5A is a step of performing predetermined error processing corresponding to a case where an authorized device/user has not been detected successfully even though the operation performed on the vehicle Hv was detected. For example, the processor 41 serving as the vehicle control unit F5 uses the in-vehicle equipment or the like to perform processing of notifying the user that the key device Kd is not found at an appropriate position. For example, the processor 41 displays, as the error processing, the predetermined failed authentication image on the display 15. The processor 41, as the error processing, may be possible to light a lighting device provided in a side mirror or the like in a predetermined pattern. Alternatively, the processor 41 may also transmit a message indicating suspected unauthorized use of the vehicle to a mail address or a management server specified as a reporting destination.

### <Key Device Management>

Whether or not to use the smart key 2 as the key device Kd on a daily basis depends on the user's preference. It is assumed that some of the users may use the mobile terminal 3 as the key device Kd and does not carry the smart key 2 at all. When there is no possibility of use of the smart key 2 as the key of the vehicle Hv, transmitting the wake signal is an unnecessary operation. From such a viewpoint, the processor 41 may also be configured to exclude the smart key 2 from daily-use devices and stop the periodic transmission of the wake signal when the smart key 2 has not been used for a given period.

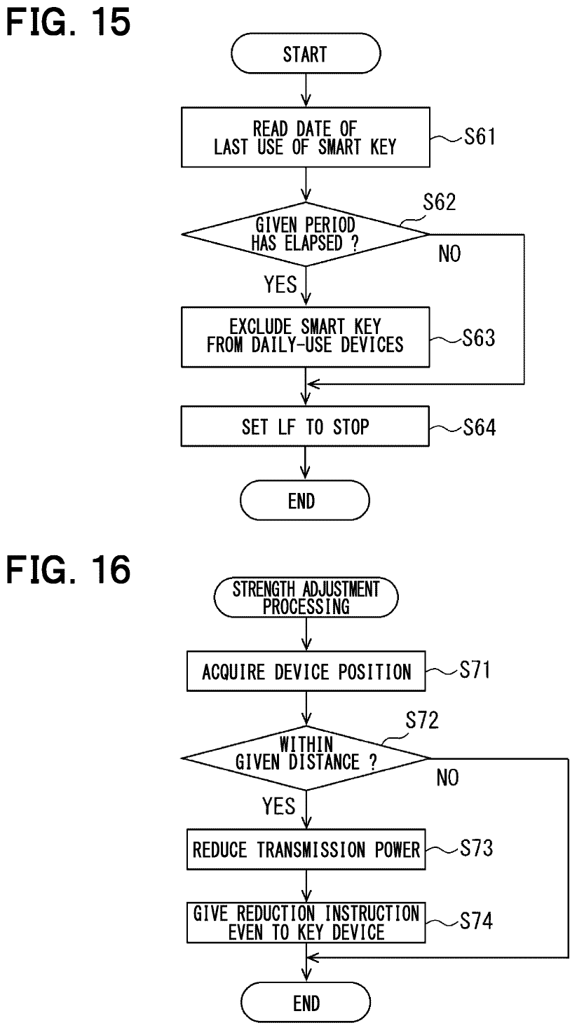

FIG. 15 illustrates an example of an operation of the processor 41 corresponding to the technical idea described above. The flow chart illustrated in FIG. 15 may be implemented every time, e.g., the driving power source is set in the ON state under the condition that the smart key 2 is registered as the daily-use device in the key information storage unit M1. On the basis of the turning ON of the driving power source, the processor 41 successively performs Steps S61 to S64 as illustrated in FIG. 15.

Step S61 is a step in which the processor 41 reads a date of last use of the smart key 2 stored in the key information storage unit M1. It is assumed that, every time the processor 41 is connected for communication to the smart key 2, the processor 41 stores the date thereof as the last use date in the key information storage unit M1.

In Step S62, the processor 41 compares the final use data to a current date to determine whether or not a predetermined invalidation period has elapsed. The invalidation period can be, e.g., a month, three months, six months, or the like. When the invalidation period has elapsed from the final use date (YES in Step S62), the processor 41 excludes the smart key 2 from a list of the daily-use devices as in Step S63.

Then, the processor 41 changes set parameters related to control of the LF transmission device 8 so as to stop the transmission of the wake signal from the LF transmission device 8, and ends the present flow (Step S64). While the description has been given heretofore by assuming a case where there is only one smart key 2 linked to the vehicle Hv, a plurality of the smart keys 2 may be issued for the one vehicle Hv as spare keys or the like. The plurality of smart keys 2 may also be distinguished from each other by key IDs. In addition, for each of the smart keys 2, whether or not the smart key 2 is the daily-use device is registered. The transmission of the wake signal needs only to be stopped when no smart key 2 is set as the daily-use device.

Instead of completely stopping the transmission of the wake signal, the processor 41 may also change the polling intervals on the basis of whether or not the smart key 2 is included in the daily-use devices. For example, when no smart key 2 is included in the daily-use devices, the polling intervals may also be elongated by predetermined amounts compared to a case where any of the smart keys 2 is included in the daily-use devices. This configuration also allows a power saving effect to be obtained. In addition, since the polling is not stopped completely, even when the user brings the smart key 2 that is not normally used, it is possible to sense approach of the user.

Alternatively, instead of automatically excluding the smart key 2 from the daily-use devices, the processor 41 may also display a deregistration proposal screen on the display 15 when an entry using the smart key 2 has not been observed for a given period. The deregistration proposal screen is a screen proposing deregistration of the smart key 2 as the key device Kd.

### <Supplementation to Control of LF Signal Transmission>

When the vehicle Hv is a service car such as a sharing car, the processor 41 may also stop the transmission of the wake signal during an LF suspension period set in advance. The suspension period is set so as to correspond to opening hours, a rental period, or the like. This is because a service user does not carry the smart key 2, and there is a high possibility that the mobile terminal 3 such as a smartphone is used as the key. Vehicle attribute information such as whether or not the vehicle Hv is a service car such as a sharing car may also be stored in the storage 43. The LF suspension period corresponds to a period during which the transmission of the wake signal is to be stopped. The set data of the LF suspension period may be manually stored by the user/staff or the like in the storage 43. Note that the set data of the LF suspension period may also be distributed from the management server and stored. When the vehicle Hv is a service car such as a sharing car, the transmission/stop of the wake signal may also be configured to be switchable by an instruction signal from the management server.

Even when the vehicle Hv is an owner car, the LF suspension period may also be configured to be registrable. The communication control unit F2 stops the transmission of the wake signal during the LF suspension period registered by the user. The LF suspension period may be manually set by the user so as to correspond to a period during which there is no possibility of using the vehicle Hv. For example, a period during which the user sleeps, a period during which the user attends classes at school, working hours, or the like can be set as the LF suspension period. The LF suspension period may also be automatically registered on the basis of use history information of the vehicle Hv. The use history information is information representing a history of times at which the driving power source is turned ON/OFF.

### <Effects, Etc.>

In the configuration described above, when not receiving the wake signal, the smart key 2 stops the BLE communication unit 23. Since a state where the BLE communication is constantly possible is not maintained, the power consumption in the smart key 2 can be reduced. As the in-vehicle system 1, scanning is performed after the wake signal is transmitted. As a result, even if the key device Kd carried by the user is the smart key 2, communication connection to the key device Kd resulting from approach of the user can promptly be carried out.

When the mobile terminal 3 is present in a neighboring area or in the vehicle interior, the smart ECU 4 stops the polling of the wake signal. If the user carries both of the smart key 2 and the mobile terminal 3, the mobile terminal 3 communicates with the BLE communication device 7, while the smart key 2 retains a sleep mode. Accordingly, the power consumption in the smart key 2 can further be reduced.

In addition, in the configuration described above, even when the communication partner is the mobile terminal 3 or the smart key 2, the smart ECU 4 performs the authentication communication by the same communication method, i.e., the BLE communication. As a comparative configuration, a configuration in which communication with the mobile terminal 3 is performed by the BLE, while communication with the smart key 2 is performed by a method other than the BLE. The method other than the BLE is a method using LF and RF (Radio Frequency) in combination, and the configuration acquires the response code from the smart key 2 by using a radio wave in the RF band. The RF mentioned herein substantially refers to a UHF (Ultra High Frequency) band including 315 MHz, 920 MHz, or the like in a technical field of a vehicular electronic key. In such a comparative configuration, the in-vehicle system 1 requires not only the BLE communication device 7, but also a RF reception device. As a result, system cost may increase. In contrast to such a comparison, according to the present embodiment, the authentication of the smart key 2 and the authentication of the mobile terminal 3 are performed using a common communication method, and therefore it is possible to accordingly reduce cost by that of the RF reception device.

While the embodiment of the present disclosure has been described heretofore, the present disclosure is not limited to the embodiment described above, and various modifications described later are also included in a technical scope of the present disclosure, and the present disclosure can be variously changed and carried out in addition to the following within a scope not departing from the gist thereof. For example, the following various modifications can be carried out in combination as appropriate within a scope that does not cause technical inconsistency. Note that members having the same functions as those of the members described above in the foregoing embodiments are denoted by the same reference signs, and a description thereof is omitted. When only a part of the configuration is mentioned, the configuration of the embodiment described previously can be applied to other parts.

### <Transmission Strength Adjustment Processing>

When determining that the key device Kd is present within a predetermined distance from the vehicle Hv, the communication control unit F2 may also change transmission power in the BLE communication device 7 to a reduced level which is lower by a predetermined amount than a predetermined standard level. With this configuration, it is possible to reduce the power consumption in the in-vehicle system 1.

FIG. 16 illustrates an example of an operation of the processor 41 corresponding to the technical idea described above. A flow chart illustrated in FIG. 16 may sequentially be implemented on the condition that the communication connection to the key device Kd is being provided. First, the processor 41 acquires the device position as, e.g., a result of the locking/unlocking area determination processing (Step S71). In other words, the processor 41 acquires the device distance in each of the outdoor devices. Then, on the basis of the presence of the outdoor device in with the device distance of less than a predetermined value (YES in Step S72), the processor 41 reduces the transmission power in each of the outdoor devices from the standard level to the reduced level (Step S73). In addition, the processor 41 transmits an instruction signal to reduce the transmission power by a predetermined amount toward the key device Kd via the BLE communication device 7x (Step S74).

A threshold to be used in Step S72 can be, e.g., 2 m, 5 m, or the like. With a configuration that performs the processing in Steps S71 to S73 described above, it is possible to reduce the power consumption in the in-vehicle system 1. Additionally, with a configuration that performs Step S74 on the condition that the key device Kd is present around the vehicle Hv, it is also possible to reduce the power consumption in the key device Kd.

Note that the adjustment of the transmission power may also be performed at multiple stages according to, e.g., the device position. Alternatively, in the same manner as with transmission power for the BLE signal, the communication control unit F2 may also adjust transmission power in the LF transmission device 8 according to the device position. For example, as the mobile terminal 3 is present closer, the transmission power for the LF signal may also be set lower.

### <Supplementation to Position Determination Method>

In the mode disclosed heretofore, the position estimation unit F3 determines that the key device Kd is present within the vehicle interior on the basis of the fact that the indoor-device observed strength (RSS_In) is not less than the inside determination value or the inside/outside difference value (ΔRSS) is not less than the difference threshold. However, this is an example and, as an algorithm for determining whether or not the key device Kd is present in the vehicle interior, various algorithms can be used.

For example, the position estimation unit F3 may also determine that the key device Kd is present in the vehicle interior on the basis of the fact that the indoor-device observed strength is not less than the inside determination value and that the outdoor-device observed strength is less than the outside determination value. In the determination algorithm, when the indoor-device observed strength is not less than the inside determination value and the outdoor-device observed strength is less than the outside determination value, it is determined that the key device Kd is present in the vehicle interior. It may also be possible to determine that the key device Kd is present outside the vehicle interior when the outdoor-device observed strength is not less than the outside determination value even though the indoor-device observed strength is not less than the inside determination value or when the indoor-device observed strength is less than the inside determination value.

Alternatively, the position estimation unit F3 may also be configured to determine whether or not the key device Kd is present in the vehicle interior by using two thresholds for the indoor-device observed strength, i.e., a HIGH-level threshold and a LOW-level threshold. The HIGH-level threshold is a threshold for determining that the key device Kd has entered the vehicle interior from outside the vehicle interior on the basis of the indoor-device observed strength. The LOW-level threshold is a threshold for determining that the key device Kd has left the vehicle interior from inside the vehicle interior on the basis of the indoor-device observed strength. The HIGH-level threshold may also be the same as the inside determination value described above. The LOW-level threshold is preferably set to a value lower than the HIGH-level threshold by 10 dB or more.

In the configuration described above, when the indoor-device observed strength has temporarily become not less than the HIGH-level threshold, the position estimation unit F3 maintains the determination that the key device Kd is present in the vehicle interior until the indoor-device observed strength becomes less than the LOW-level threshold. Meanwhile, when the indoor-device observed strength has temporarily become less than the LOW-level threshold, the position estimation unit F3 maintains the determination that the key device Kd is present outside the vehicle interior until the indoor-device observed strength becomes not less than the HIGH-level threshold. In this case, the outdoor-device observed strength is not used. Therefore, it becomes possible to omit the processing of calculating the outdoor-device observed strength.

The description has been given of an example of the method of determining whether or not the key device Kd is present in the vehicle interior. To determination of whether or not the key device Kd is present in the locking/unlocking area Lx also, various determination algorithms are applicable in the same manner as to the determination of whether or not the key device Kd is present in the vehicle interior. As the determination method for the key device Kd, for example, methods disclosed in Patent Literature 3: JP2020-26996A, Patent Literature 4: JP2020-26998A, Patent Literature 5: JP2019-158765A, Patent Literature 6: JP2019-73960A can be incorporated by reference.

When periodically determining the position of the key device Kd, the processor 41 may also finally determine a current position by using a latest determination result and previous determination results in combination. For example, when the previous two determinations results are outside the locking/unlocking area Lx and the latest determination result is within the locking/unlocking area Lx, the current position of the key device Kd is finally determined to be outside the locking/unlocking area Lx. Meanwhile, when, e.g., the second previous determination result is outside the locking/unlocking area Lx and the previous and latest determination results are within the locking/unlocking area Lx, the current position of the key device Kd is finally determined to be within the locking/unlocking area Lx. Such a configuration corresponds to a configuration that determines the final device position through majority voting/averaging using the previous determination results and the latest determination result as a population.

The configuration that determines the final current position by using the latest determination result and the previous determination results in combination can reduce a risk of erroneous determination of the device position due to momentary noise or the like. Note that this technical idea is applicable not only to the configuration that determines the device position on a per area basis, but also to a case where the device position is determined on the basis of position coordinates, as will be separately described later. In a configuration that calculates coordinates of a relative position of the key device Kd with respect to the vehicle Hv, the final position coordinates may also be determined by performing weighted averaging of results of a predetermined number of previous estimations and a result of the latest estimation.

The processor 41 may also change the number of times ranging is to be performed depending on whether or not the key device Kd serving as the communication partner is the smart key 2 or the mobile terminal 3. For example, when the communication partner is the mobile terminal 3, while the mobile terminal 3 stays outside the vehicle interior, the ranging communication is continuously/periodically performed. Meanwhile, when the communication partner is the smart key 2, the ranging communication is performed only when a user operation performed on the vehicle Hv is sensed. This configuration allows a frequency of communication with the smart key 2 to be reduced, and consequently power consumption in the smart key 2 can be reduced.

The processor 41 may also change a communication frequency/communication interval depending on whether the key device Kd serving as the communication partner is the smart key 2 or the mobile terminal 3. For example, when the communication partner is the mobile terminal 3, the communication is performed at a predetermined standard interval. Meanwhile, when the communication partner is the smart key 2, communication is performed at power saving intervals each longer than a standard interval by a predetermined amount. When it is assumed that the standard interval is 25 milliseconds, 50 milliseconds, 100 milliseconds, or the like, the power saving interval can be 200 milliseconds, 400 milliseconds, or the like. The power saving interval may also be double the standard interval or the like. This configuration also allows the power consumption in the smart key 2 can be reduced.

The position estimation unit F3 may also be configured so as to calculate relative two-dimensional/three-dimensional position coordinates of the key device Kd with respect to the vehicle Hv. For example, the position estimation unit F3 may also specify the position of the key device Kd by an RSSI method using the reception strength of the signal from the key device Kd. The RSSI method is a method of estimating a distance from each of the BLE communication devices 7 to the key device Kd by using such a property that an electric field strength of a radio signal attenuates with a propagation distance and estimating the device position on the basis of the distance from each of the BLE communication devices 7.

The position estimation unit F3 converts information on the reception strength of the signal from the key device Kd, which has been observed in each of the BLE communication devices 7, to distance information, and generates information on the distance from each of the BLE communication devices 7 to the key device Kd. Then, by integrating information on the distances from the individual BLE communication devices 7 to the key device Kd, the position estimation unit F3 calculates the position coordinates of the key device Kd. For example, the position estimation unit F3 specifies the position of the key device Kd with respect to a reference point of the vehicle Hv by a principle of trigonometry/triangulation on the basis of distances calculated from the respective reception strengths observed in the three or more BLE communication devices 7 and positions at which the BLE communication devices 7 are mounted. Conversion from a reception strength to distance information can be implemented by using a model expression such that the reception strength attenuates in inverse proportion to a cube or square of a distance. The position of the key device Kd with respect to the vehicle Hv can be represented as a point in a vehicle coordinate system.

Note that, in another mode, the position estimation unit F3 may also specify the position of the key device Kd with respect to the vehicle Hv by using an AoA (Angle of Arrival) method using an arrival angle of a radio wave. Alternatively, the position estimation unit F3 may also specify the position coordinates of the key device Kd with respect to the vehicle Hv by using the device distance from each of the BLE communication devices 7 based on ToF/two-frequency phase difference/RTT. Still alternatively, the position of the key device Kd with respect to the vehicle Hv may also be specified by using a TDOA (Time Difference of Arrival) method which performs localization by using an arrival time difference between radio waves.

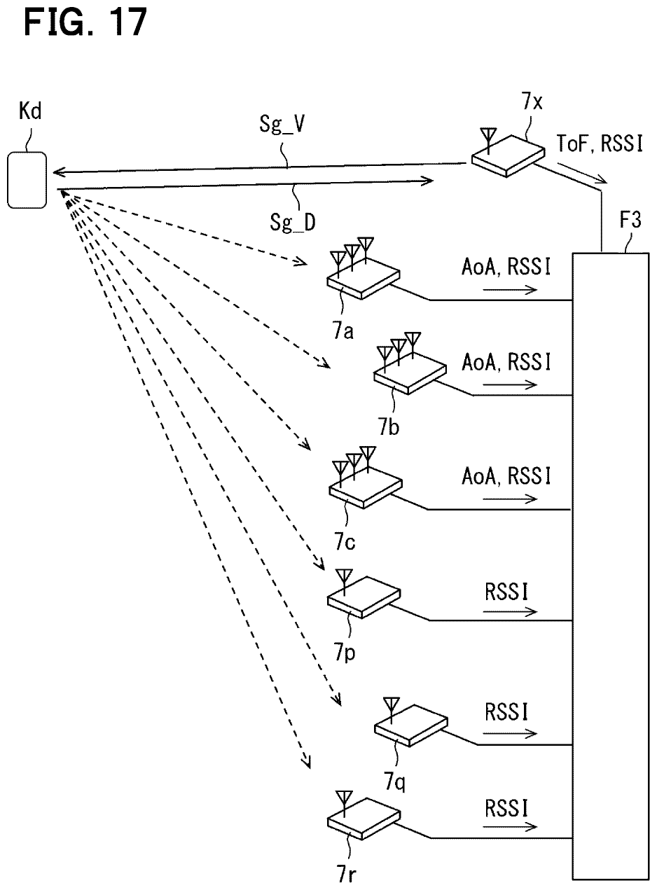

Yet alternatively, the position estimation unit F3 may also estimate the position coordinates of the device by combining a plurality of position estimation methods. For example, as illustrated in FIG. 17, the smart ECU 4 may also estimate the device position by combining the RSSI method/ToF method and the AoA method. Sg_V shown in FIG. 17 represents a signal transmitted from the in-vehicle system 1, specifically the BLE communication device 7x serving as a representative device. Sg_V may be a data signal specifying the key device Kd as a destination, or may also be a scan request signal. Sg_D may be a CW signal.

For example, the BLE communication devices 7a to 7c output arrival angles (i.e., arrival directions) and the reception strengths of the signal from the key device Kd, while the BLE communication devices 7p to 7r output the reception strengths. The BLE communication device 7x performs the ranging communication and provides ToF or a ToF-related value to the processor 41. In this case, the position estimation unit F3 can estimate the device position by combining the arrival direction observed in at least any of the BLE communication devices 7a to 7c and 7x and the reception strength observed in at least any of the BLE communication devices 7p to 7r. Needless to say, the distance information from the BLE communication device 7x based on the ToF-related value may also be used in combination. It is assumed that the BLE communication device 7 that estimates the arrival direction includes a plurality of the antennas 72 as an array antenna. The BLE communication device 7 including the array antenna may calculate the arrival direction by analyzing the reception result and report the arrival direction to the smart ECU 4.

The plurality of BLE communication devices 7 may also be configured to calculate at least any one of the reception strength, the arrival direction, and the flight time by individually performing transmission/reception of radio signals to/from the key device Kd.

Alternatively, the position estimation unit F3 may also determine the position of the smart key 2 by using the reception strength when the smart key 2 receives the wake signal complementally to communication status data in the plurality of BLE communication devices 7. In that case, the smart key 2 detects the reception strength of the wake signal as an LF reception strength, while transmitting data representing the LF reception strength to the in-vehicle system 1 by the BLE communication. The position estimation unit F3 may also determine that the smart key 2 is within the locking/unlocking area Lx or in the vehicle interior on the condition that, e.g., the LF reception strength observed by the smart key 2 is not less than a predetermined threshold. The position estimation unit F3 may also determine that, even in a case where a BLE signal reception status satisfies a condition under which it can be considered that the smart key 2 is present within the locking/unlocking area Lx, when the LF reception strength is not more than the predetermined threshold, the smart key 2 is outside the locking/unlocking area Lx.

### <Supplementation to LF Control Using Device Position Information>

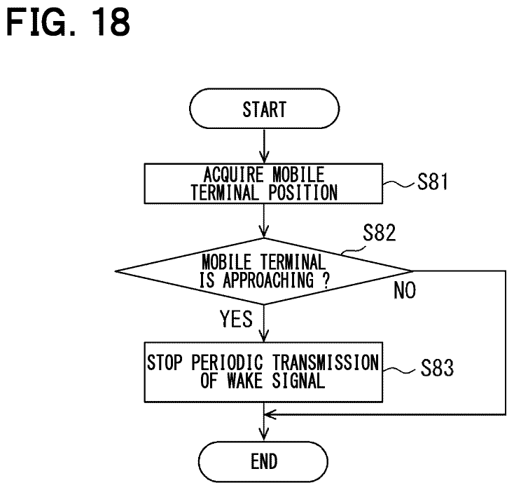

The position estimation unit F3 may also determine, on the basis of a history of position coordinates of the mobile terminal 3 or a history of a distance to the closest communication device, whether or not the user carrying the mobile terminal 3 is approaching the vehicle Hv. The communication control unit F2 may also stop the periodic transmission of the wake signal on the basis the determination that the user carrying the mobile terminal 3 is approaching the vehicle Hv. FIG. 18 is a flow chart illustrating an example of an operation of the smart ECU 4 corresponding to the technical idea described.

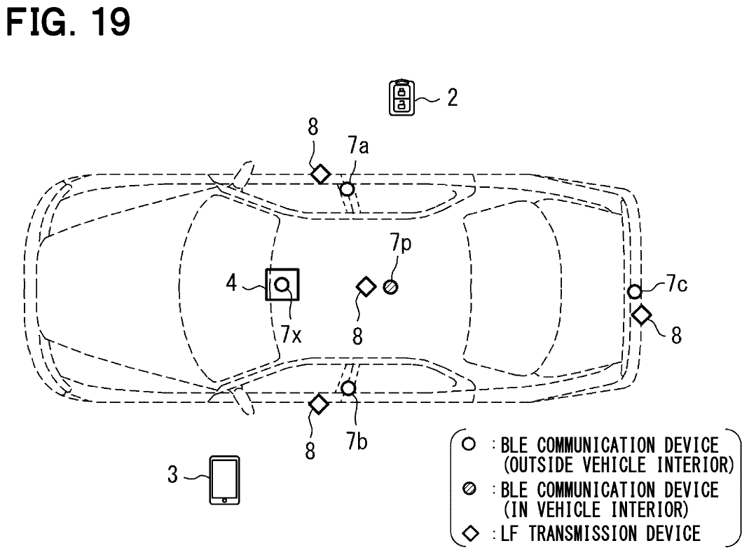

As also illustrated in FIG. 19, when the LF transmission devices 8 are dispersedly disposed in, e.g., the driver seat door, the front passenger seat door, and the trunk door, it may also be possible to cause the LF transmission device 8 in an area where the mobile terminal 3 is not detected to periodically transmit the wake signal. For example, when it is determined that the mobile terminal 3 is present in the vicinity of the front passenger seat door, it may also be possible to cause the LF transmission device 8 in the trunk door or the driver seat door to periodically transmit the wake signal. Such a configuration allows a quick response to be made even to approach of the user carrying only the smart key 2. It is assumed that each of the LF transmission devices 8 is designed to have different wake-signal transmission ranges.

### <Supplementation to Method of Detecting Transmission-Reception Phase Difference>

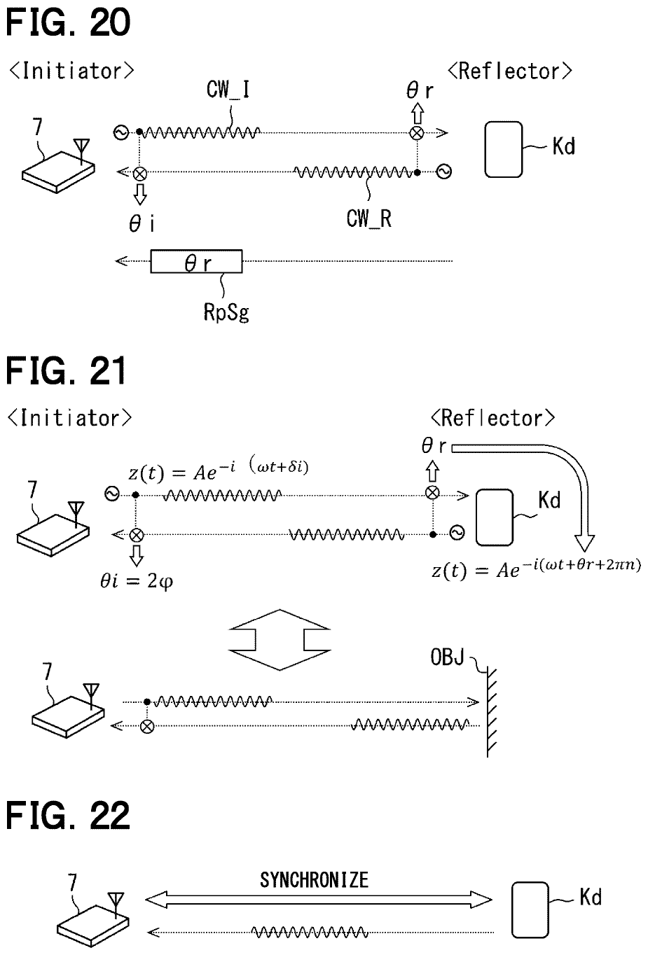

As a method of detecting the transmission-reception phase difference, there are an active two-way method, a passive two-way method, a one-way method, or the like. As illustrated in FIG. 20, in the active two-way method, an initiator and a reflector transmit/receive CW signals to/from each other to individually detect a phase difference between the transmitted signal and the received signal. According to the method, the phase differences observed by the reflector are then collected by the initiator to allow the transmission-reception phase difference to be specified. The initiator is a device that initiates communication, i.e., a device that requests a response. The reflector is a device that returns the response. Here, the BLE communication device 7 corresponds to the initiator, while the key device Kd corresponds to the reflector. The key device Kd indicating. The reflector may be referred to also as a responder. In the active two-way method, the key device Kd serving as the reflector transmits a phase report signal (RpSg) indicating the phase difference (θr) observed thereby separately from the CW signal.

CW_I shown in FIG. 20 is the CW signal transmitted by the initiator, and an initial phase is assumed to be δi. CW_R is the CW signal transmitted from the reflector, and an initial phase is assumed to be δr. When it is assumed that a phase difference according to an initiator-reflector one-way distance to be intrinsically observed is φ and a target frequency is f, θr=φ+δi−δr is satisfied. Meanwhile, θi=φ−δi+δr is satisfied. RpSg shown in FIG. 20 is a reception phase report signal including information on the reception phase (θr) observed by the reflector.

The initiator uses, as a transmission-reception phase difference (φ), an average value of the phase angle (θi) observed thereby and a phase angle (θr) observed by the reflector. Note that, since a phase difference due to one-way propagation is assumed herein, the average value of θi and θr is assumed to be the transmission-reception phase difference. In another mode, when a phase difference due to round-trip propagation is assumed as the transmission/reception phase difference, the transmission-reception phase difference can be obtained on the basis of θi+θr=2φ.

The phase difference (θi, θr) observed in each of the devices may include an initial phase (δi, δr) when each of the devices transmits a signal. However, in the average value of the phase differences observed in the individual devices, an initial phase component in each of the devices is cancelled out. According to the method described above, even when the initial phases of the CW signals transmitted from the individual devices are unknown, the transmission-reception phase differences can be calculated. Note that the key device Kd serving as the reflector may individually transmit the reception phase report signal at each frequency, or may also collectively transmit the reception phases at a plurality of frequencies.

The passive two-way method is also a method in which, as illustrated in FIG. 21, the initiator and the reflector transmit/receive the CW signals to/from each other. A difference from the active two-way method lies in that the reflector reflects the reception phase of the CW signal transmitted from the initiator on the initial phase of the transmitted signal, and then transmits the CW signal. For example, when the reception phase in the reflector is θr, the CW signal represented by z(t)=A·exp{−i(ωt+θr+2πn)} is transmitted. A represents an amplitude. ω is an angular frequency corresponding to the target frequency (f), and satisfies a relationship given by ω=2πf. n is a natural number, and corresponds to an interval from the reception of the CW signal by the reflector to the transmission of the CW signal thereby.

According to a method as described above, the reception phase observed by the initiator has substantially the same value as that when the CW signal reflected by a reflecting object OBJ such as a wall and returned is received. Accordingly, the reception phase observed in the initiator has a value obtained by cancelling out the initial phase component in the initiator. As a result, the transmission-reception phase difference is obtained. Note that, the passive two-way method has an advantage over the active two-way method such that the reflector need not transmit the phase report signal (RpSg).

As illustrated in FIG. 22, the one-way method is a method in which, on the assumption that an initial phase/local oscillator are synchronized between the devices, the reception phase of the CW signal transmitted from the key device Kd is used directly as the transmission-reception phase difference. The synchronization of the initial phase/local oscillator between the devices may be implemented by, e.g., transmitting a predetermined synchronization signal. A method of specifying the transmission-reception phase difference is not limited to the method described above, and various methods can be used. The key device Kd may be configured to operate so as to correspond to a method used by the system.

### <Supplementation to Method of ToF Measurement by Observation Device>

Estimation of the device distance/ToF using the RTT may also be performed by incorporating the method described in Patent Literature 3: JP2020-26996A. Instead of the plurality BLE communication devices 7 communicating with the key device Kd, it may also be possible to calculate the distance from each of the observation devices to the key device Kd according to the sniffing method. For example, the BLE communication device 7x serving as the representative device measures the RTT from the transmission of the response request signal to the reception of the response signal from the key device Kd, and reports the RTT to the smart ECU 4. The observation device, which is the BLE communication device 7 other than the representative device, measures the reception interval between the reception of the response request signal issued by the representative device and the reception of the response signal issued by the key device Kd, and reports the reception interval to the smart ECU 4. The smart ECU 4 specifies, on the basis of the RTT, a first flight time which is a key device-representative device signal flight time. In addition, the smart ECU 4 specifies, on the basis of each of the reception interval in the observation device and the first flight time, a second flight time which is a key device-observation device signal flight time. Each of the first flight time and the second flight time corresponds to the ToF.

Alternatively, instead of the plurality of BLE communication devices 7 individually communicating with the key device Kd, it may also be possible to calculate the transmission-reception phase difference as an index of the distance from the observation device to the key device Kd according to the sniffing method. The observation device may also specify the transmission-reception phase difference in the observation device by combining the reception phase of the CW signal issued from the representative device with the reception phase of the CW signal issued from the key device Kd.

### <Modification of Communication Device Mounting Pattern>

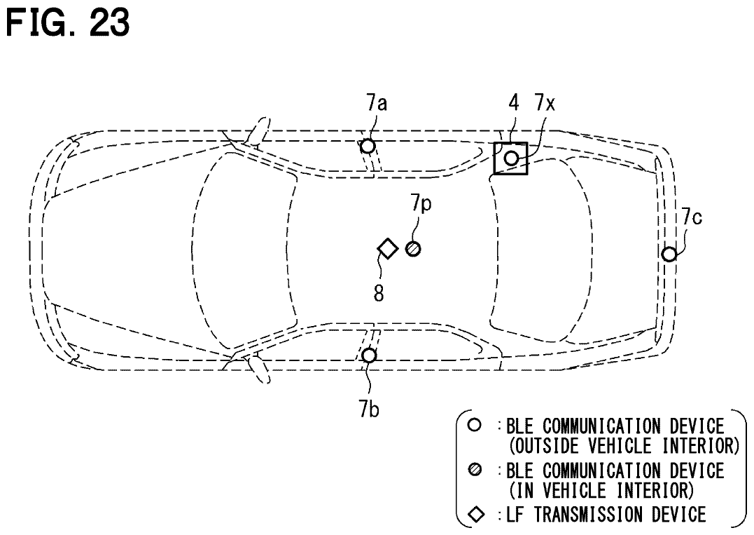

The number of the BLE communication devices 7 and the LF transmission devices 8 which are mounted in the in-vehicle system 1 and locations at which the devices 7 and 8 are mounted therein may also be in a mode illustrated in FIG. 23. In other words, the BLE communication device 7p may also be the only one indoor device. For example, the BLE communication device 7p may be disposed on a floor portion between the driver seat and the front passenger seat or in the center console or the like so as to reduce the possibility of leakage of a radio wave to the outside of the vehicle interior. The number of the LF transmission devices 8 may also be only one. To allow the radio wave to be excellently propagated even to the outside of the vehicle interior, the LF transmission device 8 may also be located at a center portion of the interior roof portion.

### <Communication Method Usable to Estimate Position of Key Device Kd>

A communication method for data communication between the in-vehicle system 1 and the mobile terminal 3 and a communication method to be used to specify the device position may also be different. For example, it may also be possible that the BLE communication is used for the data communication between the in-vehicle system 1 and the mobile terminal 3, while UWB communication may also be used to specify the device position. The UWB communication refers to communication using the UWB-IR (Ultra Wide Band-Impulse Radio) technology. Hereinbelow, a system configuration using the UWB communication to estimate the position of the terminal is referred to as a UWB combination configuration.

In the UWB combination configuration, each of the smart key 2 and the mobile terminal 3, which may serve as the key device Kd, includes, in addition to the BLE communication unit, a circuit module for transmitting/receiving an impulse-like radio wave (hereinafter referred to as the impulse signal) to be used in the UWB communication. The in-vehicle system 1 includes a plurality of UWB communication devices 9. The UWB communication device 9 is a communication module for receiving the impulse signal used in the UWB communication. The impulse signal used in the UWB communication is an extremely-short-time signal with a pulse width of, e.g., 2 nanoseconds. The UWB communication may be referred to also as ultra-wideband communication. Examples of a frequency band that can be used for the UWB communication are 3.1 GHz to 10.6 GHz, 3.4 GHz to 4.8 GHz, 22 GHz to 29 GHz, and the like.

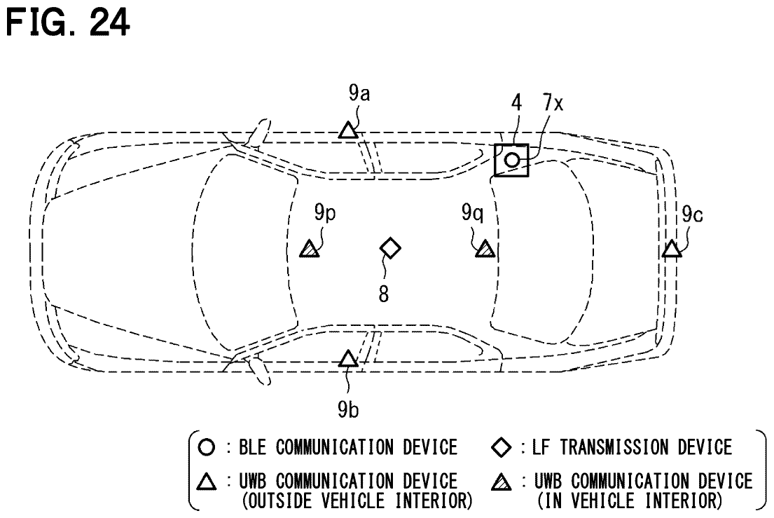

As illustrated in FIG. 24, the in-vehicle system 1 includes UWB communication devices 9a to 9c, and 9p to 9q, for example. A UWB communication device 9a is provided on an outer surface of the B-pillar at an outer door. A UWB communication device 9b is provided on an outer surface of the B-pillar at a left door. A UWB communication device 9c is located at a middle portion of a rear bumper in a leftward/rightward direction. The UWB communication devices 9a to 9c correspond to outdoor devices which are the UWB communication devices 9 provided in the outer surface of the vehicle. A UWB communication device 9p is provided at, e.g., a position in front of the center portion of the interior roof portion by a predetermined distance. The UWB communication device 9p is provided at, e.g., a position behind the center portion of the interior roof portion by a predetermined distance.

The position estimation unit F3 causes each of the plurality of UWB communication devices 9 to transmit/receive the impulse signal to/from the key device Kd in a predetermined order to estimate the distance from each of the UWB communication devices 9 to the key device Kd. As estimation of distance, ToF method or the like can be used. Then, on the basis of each of information on the distances from the individual UWB communication devices 9 to the key device Kd and the communication device setting data of the individual UWB communication devices 9, the position of the key device Kd is estimated. Thus, even when the UWB communication devices 9 are used instead of the BLE communication devices 7, the device position can be estimated. In other words, the BLE communication devices 7 in the present description can be implemented in place of the UWB communication devices 9. The BLE communication device 7 and the UWB communication device 9 correspond to the first communication unit, and the LF transmission device 8 correspond to the second communication unit.

### ADDITIONAL NOTES

The device, the system, and the method therefor which have been described in the present disclosure may also be implemented by a dedicated computer which forms a processor programmed to perform one or more functions embodied by computer programs. Alternatively, the device and the method therefor described in the present disclosure may also be implemented by using a dedicated hardware logic circuit. Still alternatively, the device and the method therefor described in the present disclosure may also be implemented by one or more dedicated computers configured by a combination of a processor that executes a computer program and one or more hardware logic circuits. For example, some or all of the functions of the smart ECU 4 may be implemented by hardware. A mode in which a certain function is implemented by hardware includes a mode in which the function is implemented by using one or more ICs or the like. As a processor (arithmetic core), CPU, MPU, GPU, DFP (Data Flow Processor) or the like can be used. Some or all of the functions of the smart ECU 4 may be implemented by combining a plurality of types of arithmetic processing devices. Some or all of the functions of the processor 41 may be implemented by a system-on-chip (SoC), a FPGA, an ASIC, or the like. ASIC is an abbreviation of Application Specific Integrated Circuit. A computer program may be stored as an instruction to be executed by a computer on a computer-readable non-transitory tangible storage medium. As program storage medium, HDD (Hard-disk Drive) and SSD (Solid State Drive), a flash memory card, or the like can be used.

What is claimed is:

1. A vehicular electronic key system, in which an in-vehicle-system is configured to perform predetermined vehicle control by performing short-range communication, which is wireless communication in compliance with a predetermined communication standard using a radio wave in a first frequency band, with a key device, which is a device to be used as a key of a vehicle, the in-vehicle system including:
a key information storage unit configured to store information on the key device;
a plurality of first communication units that are communication modules configured to perform the short-range communication;
at least one second communication unit that is a communication module configured to
transmit a predetermined wake signal, which is a wireless signal in a second frequency band different from the first frequency band, and
temporarily transition a vehicular mobile device, which is a dedicated device to operate the vehicle, to a state where the short-range communication is possible;
a communication control unit configured to control an operation of each of the first communication units and the second communication unit;
a position estimation unit configured to determine a position of the key device with respect to the vehicle, based on statuses of signal reception from the key device by the plurality of first communication units; and
an authentication processing unit configured to authenticate a user based on data received from the key device by the first communication units,
the key information storage unit is configured to register, as the key device, each of the vehicular mobile device and a mobile terminal, which is a versatile information processing device capable of performing the short-range communication,
the communication control unit is configured to change, when the mobile terminal is registered as the key device, the operation of the second communication unit, according to the position of the mobile terminal determined by the position estimation unit,
the position estimation unit is configured to determine, based on statuses of signal reception from the mobile terminal by the plurality of first communication units, whether the mobile terminal is present in a distant area, which is distant from the vehicle by a predetermined distance or more, or in an area, which is distant from the vehicle by a distance less than the predetermined distance, and
the communication control unit is configured to
when the position estimation unit determines that the mobile terminal is present in the distant area, cause the second communication unit to periodically transmit the wake signal at predetermined polling intervals, and
when the position estimation unit determines that the mobile terminal is present in the area, which is distant from the vehicle by the distance less than the predetermined distance, set the polling intervals of the wake signal to be longer than the polling intervals when the position estimation unit determines that the mobile terminal is present in the distant area.

2. The vehicular electronic key system according to claim 1, wherein
the position estimation unit is configured determine, based on the statuses of signal reception from the mobile terminal by the plurality of first communication units, whether the mobile terminal is present in a predetermined operation area, which is outside a vehicle interior or in the vehicle interior, and
the communication control unit is configured to
cause the second communication unit to periodically transmit the wake signal based on determination that the mobile terminal is present neither in the vehicle interior nor in the operation area,
cause the second communication unit to stop the periodic transmission of the wake signal based on determination that the mobile terminal is present in the vehicle interior or in the operation area.

3. The vehicular electronic key system according to claim 1, wherein
the position estimation unit is configured to determine whether the user carrying the mobile terminal is approaching the vehicle based on a history of the position of the mobile terminal, and
the communication control unit is configured to stop the second communication unit based on the determination that the user carrying the mobile terminal is approaching.

4. The vehicular electronic key system according to claim 1, wherein
the second communication unit includes a plurality of second communication units located at different positions in the vehicle and having different transmission ranges for the wake signal,
the position estimation unit is configured to specify position coordinates of the mobile terminal with respect to the vehicle based on the statuses of signal reception from the mobile terminal by the plurality of first communication units, and
the communication control unit is configured to cause the second communication unit, which has the transmission range not including the position coordinates of the mobile terminal specified by the position estimation unit, to periodically transmit the wake signal.

5. The vehicular electronic key system according to claim 1, wherein
the communication control unit is configured to
specify, based on an input signal from a member that is to be operated by the user, an operation member position, which is a position of a member operated by the user, and
cause the second communication unit to transmit the wake signal based on a mismatch between the operation member position and the position of the mobile terminal.

6. The vehicular electronic key system according to claim 1, wherein
the in-vehicle system further includes:
a device management unit configured to manage information on a device registered as the key device, and
the device management unit is configured to
display, on a predetermined display, a device registration screen, which is a screen for newly registering the key device, based on an operation signal of the user output from an input device,
newly register, as the key device, the mobile terminal or the vehicular mobile device based on the operation signal of the user from the input device during the display of the device registration screen,
acquire, as device type information, whether a registration target device, which is a device to be newly registered as the key device, is the vehicular mobile device, based on the signal from the input device, and
store, in the key information storage unit, a device ID, which is an identifier of the registration target device together with the device type information.

7. The vehicular electronic key system according to claim 6, wherein
the device management unit is configured to delete the vehicular mobile device from a list of the key devices based on the signal from the input device.

8. The vehicular electronic key system according to claim 6, wherein
the communication control unit is configured to change the operation of the second communication unit based on whether the vehicular mobile device is registered as the key device in the key information storage unit.

9. The vehicular electronic key system according to claim 6, wherein
the communication control unit is configured not to operate the second communication unit when the vehicular mobile device is not registered as the key device in the key information storage unit.

10. The vehicular electronic key system according to claim 6, wherein
the device management unit is configured to display, on the display, a screen proposing to delete the vehicular mobile device from a list of the key devices,
when the short-range communication has not been performed with the vehicular mobile device for a predetermined period or longer,
in a state where the vehicular mobile device is registered as the key device in the key information storage unit.

11. The vehicular electronic key system according to claim 1, wherein
the communication control unit is configured to cause the second communication unit to stop the periodic transmission of the wake signal during a downtime period registered by the user.

12. The vehicular electronic key system according to claim 1, wherein
the communication control unit is configured to stop the second communication unit based on an instruction from an external server.

13. The vehicular electronic key system according to claim 1, wherein
the communication control unit is configured to reduce transmission power in each of the first communication units to a reduced level lower than a predetermined standard level by a predetermined amount, when the mobile terminal is present within a predetermined distance from the vehicle.

14. The vehicular electronic key system according to claim 13, wherein
the position estimation unit is configured to
perform, as long as the position estimation unit receives a signal from the mobile terminal, processing for determining the position of the mobile terminal at predetermined intervals and
combine a previous determination result with a latest determination result to determine the position of the mobile terminal.

15. The vehicular electronic key system according to claim 1, wherein
the position estimation unit is configured to further determine a position of the vehicular mobile device with respect to the vehicle, based on statuses of signal reception from the vehicular mobile device by the plurality of first communication units, and
the communication control unit is configured to change a frequency, with which communication for determining the position is to be performed, depending on whether a communication partner is the vehicular mobile device or the mobile terminal.

16. The vehicular electronic key system according to claim 15, wherein
the position estimation unit is configured to
acquire information, which indicates a reception strength of the wake signal, from the vehicular mobile device, and
determine the position of the vehicular mobile device further based on the reception strength of the wake signal by the vehicular mobile device, in addition to the statuses of signal reception from the vehicular mobile device in the plurality of first communication units.

17. A vehicular authentication device configured to authenticate a user by performing short-range communication, which is wireless communication in compliance with a predetermined communication standard using a radio wave in a predetermined first frequency band, with a key device, which is a device to be used as a key of a vehicle, the vehicular authentication device comprising:
a key information storage unit configured to store information on the key device;
a first communication control unit configured to control a plurality of first communication units, which are communication modules located at different positions in the vehicle to perform the short-range communication;
a second communication control unit configured to control at least one second communication unit, which is a communication module configured to transmit a predetermined wake signal, which is a wireless signal in a second frequency band different from the first frequency band to temporarily transition a vehicular mobile device, which is a dedicated device to operate the vehicle, to a state where the short-range communication is possible; and
a position estimation unit configured to determine a position of the key device with respect to the vehicle, based on statuses of signal reception from the key device by the plurality of first communication units, wherein
the key information storage unit is configured to register, as the key device, each of the vehicular mobile device and a mobile terminal, which is a versatile information processing device capable of performing the short-range communication, and
the second communication control unit is configured to change, when the mobile terminal is registered as the key device, an operation of the second communication unit according to the position of the mobile terminal determined by the position estimation unit.

18. A vehicular electronic key system, in which an in-vehicle-system is configured to perform predetermined vehicle control by performing short-range communication, which is wireless communication in compliance with a predetermined communication standard using a radio wave in a first frequency band, with a key device, which is a device to be used as a key of a vehicle, the in-vehicle system comprising:
a plurality of first communication units that are communication modules configured to perform the short-range communication;
at least one second communication unit that is a communication module configured to
transmit a predetermined wake signal, which is a wireless signal in a second frequency band different from the first frequency band, and
temporarily transition a vehicular mobile device, which is a dedicated device to operate the vehicle, to a state where the short-range communication is possible; and
at least one of (i) a circuit and (ii) a processor having a memory storing computer program code, wherein the at least one of the circuit and the processor having the memory is configured to cause the vehicular electronic key system to
store information on the key device,
control an operation of each of the first communication units and the second communication unit,
determine a position of the key device with respect to the vehicle, based on statuses of signal reception from the key device by the plurality of first communication units,
authenticate a user based on data received from the key device by the first communication units,
register, as the key device, each of the vehicular mobile device and a mobile terminal, which is a versatile information processing device capable of performing the short-range communication,
change, when the mobile terminal is registered as the key device, the operation of the second communication unit, according to the position of the mobile terminal as determined,
determine, based on statuses of signal reception from the mobile terminal by the plurality of first communication units, whether the mobile terminal is present in a distant area, which is distant from the vehicle by a predetermined distance or more, or in an area, which is distant from the vehicle by a distance less than the predetermined distance, and
based on determination that the mobile terminal is present in the distant area, cause the second communication unit to periodically transmit the wake signal at predetermined polling intervals, and
based on determination that the mobile terminal is present in the area, which is distant from the vehicle by the distance less than the predetermined distance, set the polling intervals of the wake signal to be longer than the polling intervals when the mobile terminal is determined to be present in the distant area.

19. A vehicular authentication device configured to authenticate a user by performing short-range communication, which is wireless communication in compliance with a predetermined communication standard using a radio wave in a predetermined first frequency band, with a key device, which is a device to be used as a key of a vehicle, the vehicular authentication device comprising:
at least one of (i) a circuit and (ii) a processor having a memory storing computer program code, wherein the at least one of the circuit and the processor having the memory is configured to cause the vehicular authentication device to
store information on the key device;
control a plurality of first communication units, which are communication modules located at different positions in the vehicle to perform the short-range communication;
control at least one second communication unit, which is a communication module configured to transmit a predetermined wake signal, which is a wireless signal in a second frequency band different from the first frequency band to temporarily transition a vehicular mobile device, which is a dedicated device to operate the vehicle, to a state where the short-range communication is possible; and
determine a position of the key device with respect to the vehicle, based on statuses of signal reception from the key device by the plurality of first communication units,
register, as the key device, each of the vehicular mobile device and a mobile terminal, which is a versatile information processing device capable of performing the short-range communication, and
change, when the mobile terminal is registered as the key device, an operation of the second communication unit according to the position of the mobile terminal determined by the position estimation unit.
